(19) United States
(12) Patent Application Publication
(10) Pub. No.: US 2025/0292079 A1
(43) Pub. Date: Sep. 18, 2025

(54) PROGRAMMING INTERFACES FOR EVALUATION OF MACHINE LEARNING MODELS

(71) Applicant: NVIDIA Corporation, Santa Clara, CA (US)

(72) Inventors: Stefana Gloginic, Culver City, CA (US); Otavio Padovani, British Columbia (CA); Yannick Polius, Longmont, CO (US); Sumeet Kumar Barua, Bengaluru (IN); Rohit Watve, Pune (IN); Nikhil Srihari, Bothell, WA (US); Suseella Panguluri, Dublin, CA (US); Eileen Margaret Peters Long, San Jose, CA (US); Nik Spirin, Redwood City, CA (US)

(21) Appl. No.: 19/040,747

(22) Filed: Jan. 29, 2025

Related U.S. Application Data
(60) Provisional application No. 63/566,735, filed on Mar. 18, 2024.

(51) Int. Cl. G06N 3/08

(52) U.S. Cl. CPC G06N 3/08

(57) ABSTRACT

Disclosed are devices, systems, and techniques for training, deployment, inference, benchmarking, and evaluation of machine learning models. Example techniques include receiving a selection of a first task for a large language model (LLM) and instantiating an execution container including one or more compute backends. The example techniques further include receiving, via an evaluation API, task data into the execution container, the task data having one or more LLM prompts. The example techniques further include executing, using the compute backend(s), the first task in the execution container to generate a task output that includes one or more LLM responses to the LLM prompt(s) or a modification of parameters of the LLM based at least on the LLM prompt(s). The example techniques further include evaluating, using evaluation benchmarks accessed by the evaluation API, the task output to obtain metrics characterizing performance of the LLM and executing a second task using the LLM.

### TECHNICAL FIELD

At least one embodiment pertains to processing resources used to perform and facilitate artificial intelligence (AI). For example, at least one embodiment pertains to efficient training, evaluating, and deploying of machine learning models using cloud-based platforms.

### BACKGROUND

Machine learning (ML) is often used in office, industrial, and hospital environments, medical imaging, robotic or vehicle automation, security applications, autonomous transportation, law enforcement, and many other settings. In particular, machine learning has applications in audio, image, and video processing, such as in voice, speech, and object recognition. One popular approach to machine learning involves training a computing system using training data (sounds, images, actions, facial expressions, texts, and/or other data) to identify patterns in the data that may facilitate data classification, such as the presence of a particular type of an object within a training image or a particular word within a training speech or text. Training can be supervised or unsupervised. Machine learning models can use various computational algorithms, such as decision tree algorithms (or other rule-based algorithms), artificial neural networks, and the like. After a deployment of a trained machine learning model-during the inference stage-new data is input into the trained machine learning model and various target objects, sounds, sentences, actions, an/or any other target patterns can be identified using patterns and features established during training.

Language models (LMs), including large language models (LLMs), vision language models (VLMs), multi-modal language models (MMLMs), etc., are machine learning models capable of supporting conversations in natural language, understanding speaker intent and emotions, explaining complex topics, generating new texts/images/audio/etc., upon receiving suitable prompts, as well as providing recommendations regarding topics of interest to a user, processing images, audios, and/or other data types, and/or performing other functions. VLMs, including VLMs or MMLMs, for example, combine visual perception with the ability to express perceived objects in texts, e.g., to perform image captioning. LLMs usually undergo self-supervised training on massive amounts of texts (and/or other data, such as audio, image, video, 2D or 3D graphics or design, etc.) while learning to predict the next and/or missing word in a phrase/sentence, detect intent and/or sentiment of a human speaker, determine if two sentences are related or unrelated, and/or perform other basic language tasks. Training of LLMs often further include instructional (prompt-based) supervised fine-tuning, which causes LLMs to acquire more in-depth language proficiency and/or master more specialized tasks, and reinforcement learning, in which a human evaluator assigns grades indicative of a quality of the LLM-generated outputs.

### BRIEF DESCRIPTION OF DRAWINGS

FIG. 1 is a block diagram of an example computing architecture capable of evaluating machine learning models (MLMs) in the context of training, deployment, fine-tuning, inferencing, and/or other suitable tasks, according to at least one embodiment;

FIG. 2 illustrates an example computing device capable of supporting evaluation of MLMs performed in the context of training, deployment, fine-tuning, inferencing, and/or other tasks, according to at least one embodiment;

FIG. 3 illustrates schematically operations of a machine learning model evaluation service, according to at least one embodiment;

FIG. 4 illustrates schematically an example container-based execution of evaluation of training of MLMs, according to at least one embodiment;

FIG. 5 illustrates schematically a flow of events during training, inference, and evaluation of MLMs, according to at least one embodiment;

FIG. 6 is a flow diagram of an example method of performing evaluation of one or more MLMs, in accordance with at least some embodiments;

FIG. 7A illustrates inference and/or training logic, according to at least one embodiment;

FIG. 7B illustrates inference and/or training logic, according to at least one embodiment;

FIG. 8 illustrates training and deployment of a neural network, according to at least one embodiment;

FIG. 9 is an example data flow diagram for an advanced computing pipeline, according to at least one embodiment;

FIG. 10 is a system diagram for an example system for training, adapting, instantiating and deploying machine learning models in an advanced computing pipeline, according to at least one embodiment;

FIG. 11A is a block diagram of an example generative language model system suitable for use in implementing at least some embodiments of the present disclosure;

FIG. 11B is a block diagram of an example embodiment in which the generative LM includes a transformer encoder-decoder, according to at least one embodiment;

FIG. 11C is a block diagram of an example embodiment in which the generative LM 1130 includes a decoder-only transformer architecture, according to at least one embodiment;

FIG. 12 is a block diagram of an example computing device suitable for use in implementing some embodiments of the present disclosure; and

FIG. 13 is a block diagram of an example data center suitable for use in implementing some embodiments of the present disclosure.

### DETAILED DESCRIPTION

Organizations and enterprises often have to train or fine-tune LLMs or other machine learning models to meet specific goals of such organizations. For example, a medical establishment (e.g., a hospital or a clinic) can be interested in fine-tuning a foundational LLM (e.g., pre-trained by another service) using specialized medical terminology/knowledge to assist medical personnel in maintaining records of the procedures, diagnostics, patient monitoring, and/or the like. An LLM fine-tuned using the establishment's own data can be capable of supporting a medical conversation with doctors, nurses, and/or patients. Additionally, organizations can maintain a database of domain-specific information that can be used for retrieval-augmented generation (RAG) of model's outputs. More specifically, RAG is the technique for improving quality of LLM's outputs by augmenting inputs (queries) into the LLM with additional information that may be of relevance to the inputs, e.g., information that includes context, data, specialized knowledge about the subject of the query, and so on. Such augmentation reduces the amount of LLM hallucinations and is widely used in applications where sensitive user data has to remain private and cannot be used in training of the foundational LLMs, which are often operating in a public domain.

An establishment can attempt to develop a specialized LLM based on multiple candidate foundational models, which can be (in some instances) facilitated with various (candidate) RAG databases, as well as use different sets of fine-tuning and/or training data. At the completion (or during various intermediate checkpoints) of such training/fine-tuning, the success or failure of training can be evaluated based on various public and/or enterprise-specific evaluation criteria or benchmarks. After such evaluations, some of the models and/or RAGs can be discarded while training of other models and/or development of RAGs can be changed, e.g., by using additional and/or different sets of data. For example, when LLMs are customized for specific tasks, it is not uncommon for the models to “unlearn” previously mastered tasks. As a result, when enterprises adopt foundational and/or pretrained LLMs for specialized training, it is important to continuously (or at least periodically) monitor the model's proficiency with respect to a multitude of previously learned, e.g., foundational, skills, to detect any occurring regression. Detected regressions can be addressed by updating the model's training using suitable sets of refresher data.

Evaluating and monitoring a model's training progress in relation to new tasks and previously learned tasks using suitably chosen sets of progress benchmarks, comparing learning progress of the model to that of other models that are being trained/evaluated concurrently (or have been trained/evaluated historically), and/or obtaining and analyzing various other evaluation data to inform user(s) about the model's capabilities and competitiveness in comparison to other models is a complex process that requires sophisticated developer's skills with expertise in efficient utilization of available software and hardware resources. Many enterprises lack sufficient knowledge and experience to perform and conduct high-quality evaluation of an LLM (or other machine learning models) and make proper evaluation-informed decisions about the model's adequacy and prospects in achieving the enterprise's objectives.

Aspects and embodiments of the present disclosure address these and other challenges of the modern AI technology by providing for methods and systems that enable efficient evaluations of LLMs and other MLMs in view of suitable evaluation metrics. In some embodiments, one or more application programming interfaces (APIs) may facilitate training, deployment, fine-tuning, inference, and evaluation of MLMs, e.g., as part of local or cloud-based computing (e.g., via a remote-access client, a browser-supported client, and/or the like). A training/deployment/inference (TDI) API may authenticate a remote user and receive one or more control commands from the user, e.g., requests to train one or more MLMs using user's or public data, fine-tune one or more pretrained MLMs, evaluate one or more trained MLMs using new data, optimize (e.g., prune and/or quantize) one or more trained/tuned MLMs for deployment on user-specified hardware, process inference data, and/or perform any other suitable MLM-related tasks. The TDI API may include (or communicate with) a workflow engine that converts control commands received from the user into low-level codes and routines that may be executed using various compute backends, e.g., TensorFlow®, PyTorch®, TensorRT®, ONNX®, Keras®, and the like. The workflow engine may evaluate the received control commands and schedule various tasks (e.g., authenticating data/model, fetching data, setting training and/or model hyperparameters, and/or the like) for execution of user's requests on selected compute backends and/or various other modules and components. The workflow engine may also allocate specific hardware resources (e.g., local or cloud) for execution of the user's requests.

In some embodiments, the workflow engine may orchestrate execution of user's tasks using insulate containers (e.g., Kubernetes containers, DOCKER containers, and/or the like). In some embodiments, a container may include a data controller that loads any suitable (training or inference) data, e.g., web address(es) of the user's cloud space together with authentication/credentials information (e.g., passwords, password hashes, etc.), generates status updates to the user about the tasks being executed, and stores intermediate data, e.g., training results, logs, model checkpoints, and/or the like.

In some embodiments, an evaluation API may operate in conjunction with the TDI API to facilitate evaluation of intermediate and/or final results of task execution. (In some embodiments, the evaluation API and the TDI API may be integrated into a single API). The evaluation API may facilitate displaying on a user interface (UI) various available evaluation benchmarks, including public evaluation benchmarks and/or proprietary evaluation benchmarks (e.g., a set of enterprise-specific benchmarks available to the user). A user may select one or more evaluation benchmarks to be used in evaluation of the user's tasks. In those instances where the user lacks sufficient expertise in selecting the benchmarks, the evaluation API may select default evaluation benchmarks, e.g., based on a type of a task being executed (e.g., different default evaluation benchmark may be used for initial training of a model than for fine-tuning of that model).

During periodic (intermediate) task checkpointing and/or after completion of the task, an intermediate and/or final task output may be stored and evaluated using the evaluation API. The task output may include responses generated by the LLM for various training, fine-tuning, and/or inference prompts. The task output may also include a modification of parameters (e.g., weights and biases) of the LLM, e.g., made to the LLM as part of the task execution (e.g., training/fine-tuning). The selected benchmarks may be applied to the task output to obtain one or more metrics characterizing performance of the LLM, e.g., accuracy (including precision, recall, F1 score, etc.) of the LLM's predictions, a degree to which the LLM responses resemble human language, a degree of safety, toxicity, and/or other metrics. In some embodiments, e.g., where the executed task(s) includes using a RAG to augment the LLM's knowledge base, the obtained metrics may further include metrics that characterize performance of the LLM operating in conjunction with the RAG.

The obtained metrics may be used to generate performance reports and/or alerts. In one example, a performance report may include one or more historical metrics characterizing past performances of the LLM during previous training, fine-tuning, and/or inference tasks. In another example, a performance report may include one or more metrics characterizing performance and/or rankings of at least one other LLM, e.g., a publicly available LLM and/or another candidate LLM being evaluated by the user to perform similar tasks. In yet another example, a performance report may include a comparison of the LLM's performances with and without the RAG. The generated performance reports may be displayed to the user via the UI. In some instances, the obtained metrics may indicate that one or more threshold conditions are satisfied (or not satisfied). The evaluation API may generate respective alerts and communicate these alerts to the user (e.g., via the UI). For example, the evaluation API may determine that the metrics indicate that the LLM has achieved a target performance and issue a positive alert. In another example, the evaluation API may determine that the improvement of the LLM caused by the task being executed is below a target improvement and issue a negative alert (e.g., indicative of inefficient training process and/or training data).

In some embodiments, the evaluation API may execute additional tasks in view of the obtained metrics. Such additional tasks may include continuing training of the LLM with additional training data, advancing the training to the next (e.g., more specialized) stage, concluding the training and deploying the LLM for inference, and/or the like. In some instances, the evaluation API may determine, in view of the obtained metrics, that the execution of the current task has resulted in a decrease of skills previously learned by the LLM. The evaluation API may then automatically schedule refreshing of these previously learned and regressed skills, and/or recommend such refresher training to the user.

The advantages of the disclosed techniques include, but are not limited to, automated and efficient evaluation of executed LLM and other MLM-related tasks in comparison with previously and/or concurrently executed tasks by the same or different models. The disclosed techniques eliminate or reduce reliance on user's experience and sophistication in running and interpreting evaluation results and selecting appropriate next stages in model training and/or deployment.

Although, for the sake of specificity and illustration, examples in the present disclosure often refer to LLMs, it should be understood that the disclosed techniques may also be applied to other MLMs and AI systems. For example, and without limitation, any of the various machine learning models and/or neural networks described herein may include any type of machine learning model, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoder neural networks, artificial neural networks (ANNs), convolutional neural networks (CNNs), recurrent neural networks (RNNs), perceptrons, Long/Short Term Memory (LSTM) networks, multi-layer perceptron (MLP) networks, deep stacking networks (DSNs), generative pre-training (GPT) models or networks, feed forward networks, radial basis function ANNs, self-organizing maps (SOMs), Kohonen maps, Hopfield networks, Boltzmann machine, deep belief neural networks, deconvolutional neural networks, generative adversarial networks (GANs), liquid state machines, modular neural networks, liquid state machines, sequence-to-sequence models, networks using transformer architectures, state space models (SSMs) (e.g., networks using Mamba architectures (e.g., Mamba-1, Mamba 2, etc.), networks using selective state space models, networks using structured state space sequence models, etc.), diffusion models (e.g., diffusion probabilistic models, score-based generative models, etc.), neural radiance field (NeRF) models, Gaussian splat models, Kolmogorov-Arnold networks (KANs), models with encoder-only architectures, models with decoder-only architectures, models with encoder-decoder architectures, generative machine learning models, language models, large language models (LLMs), vision language models (VLMs), multi-modal language models (MMLMs), large action models (LAMs), etc.), and/or other types of machine learning models or architectures.

Further, when reference is made to “training” of models it should be understood that the disclosed techniques or operations can also be used for fine-tuning, updating (e.g., parameters of the models), re-training, and/or other suitable techniques of modifying models to improve their outputs according to target criteria.

### System Architecture

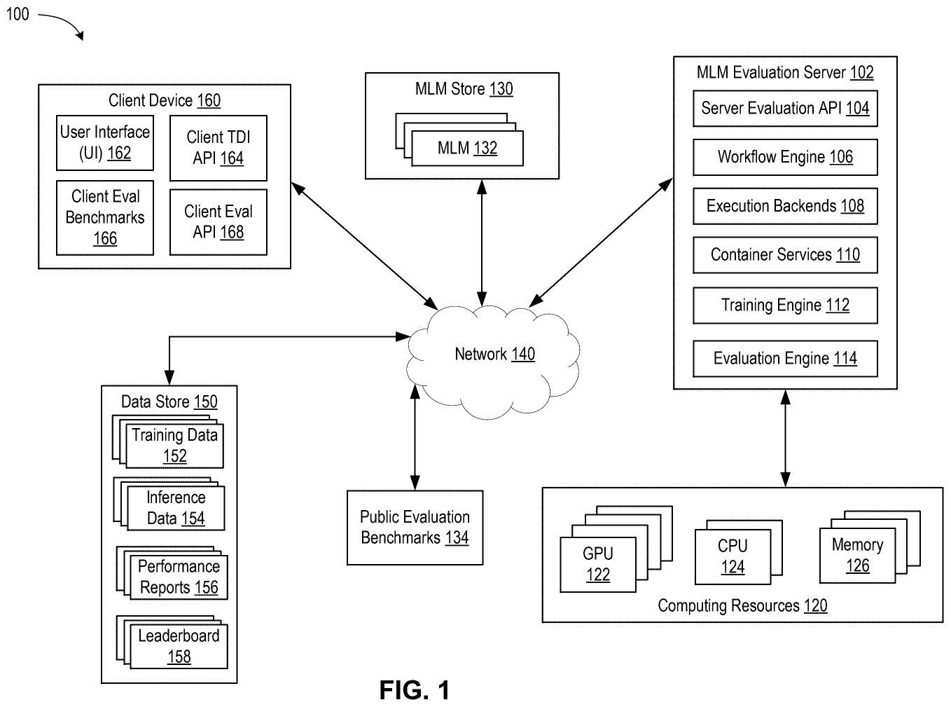

FIG. 1 is a block diagram of an example computing architecture 100 capable of evaluating machine learning models (MLMs) in the context of training, deployment, fine-tuning, inferencing, benchmarking, and/or other suitable tasks, according to at least one embodiment. As depicted in FIG. 1, computing architecture 100 may be implemented on multiple computing devices, including an MLM evaluation server 102 and a client device 160, etc., and may further use multiple data repositories, including but not limited to an MLM store 130 and data store 150. In some embodiments, any of the modules and/or components of computing architecture 100 may be implemented using more or fewer devices than shown in FIG. 1. In some embodiments, any of the modules and components of computing architecture 100 may be implemented on a single computing device, e.g., MLM evaluation server 102.

The MLM(s) evaluated using a system illustrated in FIG. 1 may include deep neural networks, language models (including LLMs, VLMs, MMLMs), perception models, tracking models, fusion models, transformer models, diffusion models, encoder-only models, decoder-only models, encoder-decoder models, neural rendering field (NERF) models, and/or any suitable models.

MLM evaluation server 102 may be or include one or more desktop computers, server computers, rackmount servers, data centers, compute centers, servers that utilize a virtualized computing environment, and/or any combination thereof. A user may have local or remote (e.g., over a network 140) access to MLM evaluation server 102. For example, the user may access MLM evaluation server 102 via client device 160, which may include one or more desktop computers, laptop computers, tablet computers, servers, computing devices that access a remote server, a gaming console, a wearable computer, a mixed/virtual/augmented reality headset, a smart TV, or any other type of computing devices, or any combination of multiple computing devices. MLM evaluation server 102 may use any number of compute platform resources 120, which may include any number of distributed computing nodes communicating via a suitable bus, interconnect, or network (e.g., network 140), and/or the like. Compute platform resources 120 may include any number of graphics processing units (GPUs) 122, central processing units (CPUs) 124, parallel processing units (PPUs), data processing units (DPUs), accelerators, field-programmable gate arrays (FPGAs), application-specific integrated circuits (ASICs), and/or other suitable processing devices capable of performing the techniques described herein. GPUs 122 and/or CPUs 124 may support any number of virtual CPUs and/or virtual GPUs. Compute platform resources 120 may further include one or more memory devices, also referred to simply as memory 126 herein, which may include read-only memory (ROM), static random-access memory (SRAM), dynamic random-access memory (DRAM), e.g., such as synchronous DRAM (SDRAM)), flash memory, and/or the like.

MLM evaluation server 102 may further have access (e.g., over network 140) to any number of peripheral devices and/or edge devices (not shown in FIG. 1), including but not limited to cameras (e.g., video cameras) for capturing images (or sequences of images, e.g., videos), microphones for capturing sounds, scanners, physical or chemical sensors, or any other devices for intake of data. In some embodiments, the data may be stored in data store 150 and may include training data 152 (e.g., data used in training, fine-tuning, or updating models) and inference data 154 (e.g., any data processed by a trained and deployed model). A user of a client device 160 may have access to at least some of training data 152 and/or inference data 154 in data store 150. In some embodiments, access to the data may be granted based on access levels, e.g., defined at individual user level, group level, organization level, and/or the like. In some implementations, evaluation of models may be performed using training data 152 and/or inference data 154, depending on a task/context in which evaluation is performed.

In some embodiments, MLM evaluation server 102 may include any number of engines and components that facilitate scalable model evaluation in the context of training, adapting, evaluating, benchmarking, optimizing, and deploying MLMs. A user (e.g., customer, end user, developer, data scientist, etc.) may interact with MLM evaluation server 102 via a user interface (UI) 162, e.g., located or rendered on client device 160. UI 162 may include a command line, a graphics-based UI, a web-based UI (e.g., a web browser-supported interface), a mobile application-based UI, or any combination thereof. UI 162 may display menus, tables, graphs, flowcharts, graphical and/or textual representations of software, dataflows, and workflows. UI 162 may include selectable items, which may allow the user to identify MLMs to be trained, optimized, and/or deployed, select hyperparameters for MLM training, location of training and inference, and/or the like.

User actions, parameters, and settings entered via UI 162 may be communicated to MLM evaluation server 102 via a client portion of training/employment/inference (TDI) API 164 installed on client device 160. The user may also be able to select, via UI 162, various client (evaluation) benchmarks 166 for evaluation of MLMs being trained and/or deployed. Client benchmarks 166 may include any set of one or more functions that can be applied to outputs of the MLMs and/or parameters of MLMs to generate objective metrics of performance MLMs and/or training evolution of MLMs. For example, client benchmarks 166 may include statistics representative of accuracy of MLM outputs with respect to any suitable inputs, e.g., inputs for which correct or target outputs—ground truth—are known. In some implementations, client benchmarks 166 may include rates at which parameters (e.g., neural weights and biases) are changing, e.g., per training epoch or some other number of training epochs or inputs, for any suitable set of training data 152.

In some implementations, client benchmarks 166 may include proprietary (e.g., to an organization employing or otherwise associated with the user) benchmarks. In some implementations, one or more public (evaluation) benchmarks 134 may be used together or instead of proprietary evaluation benchmarks. In some implementations, the user may be able to select client benchmarks 162 and/or public benchmarks 134 via a client portion of an evaluation API 168 installed on client device 160, which displays various available evaluation benchmarks on UI 162. In those instances where the user lacks sufficient expertise in selecting the benchmarks, the evaluation API may select default evaluation benchmarks, e.g., based on a type of an MLM being trained (e.g., different default evaluation benchmarks may be used for LLMs than for object recognition MLMs), a type of a task being executed (e.g., different default evaluation benchmarks may be used for initial training of a model than for fine-tuning of that model), and so on. The evaluation API may then facilitate exchange of evaluation data with the user. The evaluation data may include various evaluation or performance reports 156, which may be displayed on UI 162, that describe performance of a given MLM in absolute terms (e.g., measured for a given set of training data 152 and/or inference data 154) or in relative terms, e.g., by comparing the current performance of the MLM to the past performance of the same MLM, comparing performance of the MLM with performances of other MLMs, and/or the like. Performance reports 156 may further include descriptions of how efficient various subsets of training data 152 are for improving different aspects of MLM performance, e.g., accuracy of user intent determination by an LLM, absence or presence of hallucinations, factual correctness of responses, a degree to which LLM responses resemble human speech or text, and/or the like. The evaluation data may further include a leaderboard 158 that illustrates, e.g., in a graphical form (e.g., using plots, charts, animations, and/or the like) performance of a given MLM relative to other models, including market leaders, publicly available models (e.g., from the same technology domain), open-source models, commercially available models, and so on.

In some embodiments, UI 162, client TDI API 164, and/or client evaluation API 168 may be downloaded to client device 160 from MLM evaluation server 102 or some other computing or memory device of the computing architecture 100. The downloaded API package(s) may be used to install UI 162, client TDI API 164, and/or client evaluation API 168 to allow the user to have a two-way communication with server portions of the respective APIs instantiated on MLM evaluation server 102. For example, client TDI API 164 may provide to the user a set of control commands that can be understood by MLM evaluation server 102 as instructions that request training, adapting, optimizing, and or deploying one or more MLMs 132, e.g., using training data 152, and/or instructions that request processing of inference data 154. Training data 152 and/or inference data 154 may be stored in data store 150 and/or generated at runtime by any sensors, such as imaging sensors, video sensors, audio sensors, physical sensors, chemical sensors, and/or any other suitable sensors, and/or any combination thereof. The control commands, made available to user via client TDI API 164, may include commands that cause MLM evaluation server 102 to train one or more MLMs, augment or annotate data used in training of the MLM(s), prune (reduce complexity by eliminating some of the neurons) of trained MLM(s), export trained MLM(s), perform inference of data using trained MLM(s), and/or the like.

Similarly, a server portion of evaluation API 104 operating on MLM evaluation server 102 may facilitate two-way communication with client evaluation API 168 to initiate, perform, and report evaluation of any suitable trained MLM, deployed MLM, and/or MLM undergoing training and/or fine-tuning (updating, retraining, and/or the like).

MLM evaluation server 102 may deploy multiple modules and components configured to process and implement one or more control commands issued by a user and received via client APIs and server APIs. Execution of commands and requests received from the user may be facilitated and managed by a workflow engine 106. Workflow engine 106 may convert control commands received from the user into low-level codes and routines that may be executed using various available execution backends (frameworks) 108, e.g., TensorFlow®, PyTorch®, TensorRT®, ONNX®, Keras®, and/or the like. Workflow engine 106 may schedule and supervise jobs on execution backends 108. Workflow engine 106 may include a dependency checker component to determine and enforce data and resource prerequisites for execution of tasks, identify and fetch dependencies, metadata, and/or the like. Workflow engine 106 may maintain a priority queue of pending and future jobs, including handling of different training (or inference) datasets for training (or performing inference using) the same model, different models selected by the same user, models selected by different users and/or user groups, and the like.

Execution backends 108 should be understood as any software resources, packages, toolkits, software development kits (SDKs) that can execute on any suitable hardware, including but not limited to one or more GPUs 122, one or more CPUs 124, and any other processing resources. Individual execution backends 108 may include executable codes, libraries, and configuration files. Execution backends 108 may be used to perform training of MLMs 132, optimization of MLMs 132, evaluation (validation) of MLMs 132, inference processing using MLMs 132, and/or perform other suitable processing operations. In some embodiments, at least some of the functionality of MLM evaluation server 102 may be supported by (e.g., split between) multiple computing devices. For example, some of execution backends 108 may be located on one or more separate computing devices connected to MLM evaluation server 102 over network 140 or a bus/interconnect.

MLM evaluation server 102 may include container services 110 for secure insular execution of various user-requested tasks, e.g., using Kubernetes containers, DOCKER containers, and/or the like. In some embodiments, MLM evaluation server 102 may further include a training engine 112 capable of executing operations that train one or more MLMs 132. In particular, training engine 112 may initiate training of one or more MLM(s) 132, e.g., by selecting training hyperparameters, choosing execution backends 108, identifying training data 152, processing the training data using the MLM(s) to generate predictions, calculating losses (departures of the predictions from target predictions), changing parameters of the MLM(s) to maximizes MLM(s) performance while satisfying suitable target criteria, and performing other functions (e.g., minimizes training time).

MLM evaluation server 102 may further include an evaluation engine 114 capable of evaluating one or more MLMs 132 undergoing training (including fine-tuning, updating, refreshing, etc.) using training data 152 and/or MLM(s) 132 deployed used for inference processing of inference data 154. In particular, the evaluation engine 114 may initiate and/or respond to MLM checkpointing events (e.g., controlled stoppages in MLM processing), e.g., by receiving or accessing outputs of MLM(s) generated in response to the training/inference data, parameters of the MLM(s) changed in the course of training (or over a number of training epochs since the last checkpointing event), and/or other suitable data, and apply evaluation benchmarks (e.g., user-selected, default, and/or selected by the evaluation engine 114), to obtain one or more metrics characterizing performance of the MLM(s). In some instances, the evaluation may be for a same model using different processing components or combinations thereof, such as running the model on a first computing setup and then the same model on another computing setup or architecture (e.g., different GPUs, hardware accelerators, networking chips (e.g., DPUs), etc.) in order to deliver information on performance across different compute offerings. As such, the metrics may be used to produce evaluation reports 156, leaderboards 158, and/or other data that may be provided to the user. In some implementations, evaluation engine 114 may automatically schedule one or more additional tasks based on the obtained metrics, e.g., to perform additional training of the MLM(s), change the scope of training, e.g., by changing or augmenting training data, and/or the like.

In some implementations, training of MLMs 132 may include re-training or advanced training of previously (e.g., initially) trained MLMs 132. In other implementations, training of MLMs 132 may include creating an MLM, e.g., by setting up an MLM type (e.g., a neural network), selecting an architecture, a number of layers of neurons, types of connections between the layers (e.g., fully connected, convolutional, deconvolutional, transformer, conformer, etc.), the number of nodes within each layer, types of activation functions used in various layers/nodes of the network, types of loss functions used in training of the network, and so on. Creating MLMs 132 may include setting (e.g., randomly) initial parameters (weights, biases) of various nodes of the networks. The generated MLMs 132 may be trained by using training data 152 that may include training input(s) and corresponding target output(s). During training of MLMs 132, a training software (e.g., executed by one of execution backends 108) may identify patterns in training input(s) based on desired target output(s) and train the respective MLMs 132 to perform desired tasks. Predictive utility of the identified patterns may subsequently be verified using additional training input/target output associations before being used for processing of new data during the inference stage.

MLMs 132 that are trained and/or used in inference may be pre-trained and stored in MLM store 130 accessible to MLM evaluation server 102 over network 140. Network 140 may be a public network (e.g., the Internet), a private network (e.g., a local area network (LAN), or wide area network (WAN)), a wireless network, a personal area network (PAN), or a combination thereof. MLMs 132 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoder neural networks, artificial neural networks (ANNs), convolutional neural networks (CNNs), recurrent neural networks (RNNs), perceptrons, Long/Short Term Memory (LSTM) networks, multi-layer perceptron (MLP) networks, deep stacking networks (DSNs), generative pre-training (GPT) models or networks, feed forward networks, radial basis function ANNs, self-organizing maps (SOMs), Kohonen maps, Hopfield networks, Boltzmann machine, deep belief neural networks, deconvolutional neural networks, generative adversarial networks (GANs), liquid state machines, modular neural networks, liquid state machines, sequence-to-sequence models, networks using transformer architectures, state space models (SSMs) (e.g., networks using Mamba architectures (e.g., Mamba-1, Mamba 2, etc.), networks using selective state space models, networks using structured state space sequence models, etc.), diffusion models (e.g., diffusion probabilistic models, score-based generative models, etc.), neural radiance field (NeRF) models, Gaussian splat models, Kolmogorov-Arnold networks (KANs), models with encoder-only architectures, models with decoder-only architectures, models with encoder-decoder architectures, generative machine learning models, language models, large language models (LLMs), vision language models (VLMs), multi-modal language models (MMLMs), large action models (LAMs), etc.), and/or other types of machine learning models or architectures.

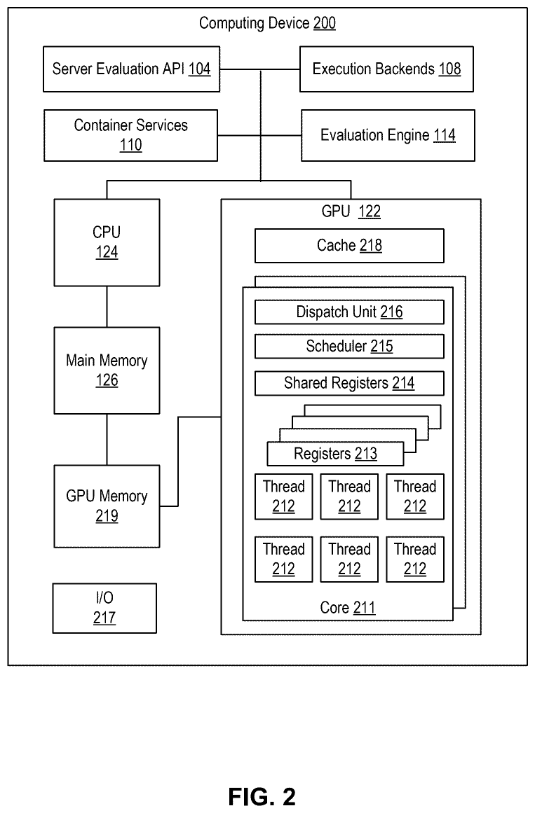

FIG. 2 illustrates an example computing device 200 capable of supporting evaluation of MLMs performed in the context of training, evaluation, deployment, fine-tuning, inferencing, and/or other tasks, according to at least one embodiment. In at least one embodiment, computing device 200 may support any, some or all of server evaluation API 104, workflow engine 106, execution backends 108, container services 110, evaluation engine 114, and/or other programs and applications (such as training engine 112) may be executed using one or more GPUs 122 (and/or other parallel processing units (PPUs) or accelerators, such as a deep learning accelerator, a data processing unit (DPU), etc.) and one or more CPUs 124. In at least one embodiment, a GPU 122 includes multiple cores 211, some or all cores being capable of executing multiple threads 212. Some or all cores may run multiple threads 212 concurrently (e.g., in parallel). In at least one embodiment, threads 212 may have access to registers 213. Registers 213 may be thread-specific registers with access to a register restricted to a respective thread. Additionally, shared registers 214 may be accessed by one or more (e.g., all) threads of the core. In at least one embodiment, some or all cores 211 may include a scheduler 215 to distribute computational tasks and processes among different threads 212 of respective core 211. A dispatch unit 216 may implement scheduled tasks on appropriate threads using correct private registers 213 and shared registers 214. Computing device 200 may include input/output component(s) 217 to facilitate exchange of information with one or more users or developers.

In at least one embodiment, GPU 122 may have a (high-speed) cache 218, access to which may be shared by multiple cores 211. Furthermore, computing device 200 may include a GPU memory 219 where GPU 122 may store intermediate and/or final results (outputs) of various computations performed by GPU 122. After completion of a particular task, GPU 122 (or CPU 124) may move the output to (main) memory 126. In at least one embodiment, CPU 124 may execute processes that involve serial computational tasks whereas GPU 122 may execute tasks (such as multiplication of inputs of a neural node by weights and adding biases) that are amenable to parallel processing. In at least one embodiment, workflow engine 106 may determine which processes are to be executed on GPU 122 and which processes are to be executed on CPU 124.

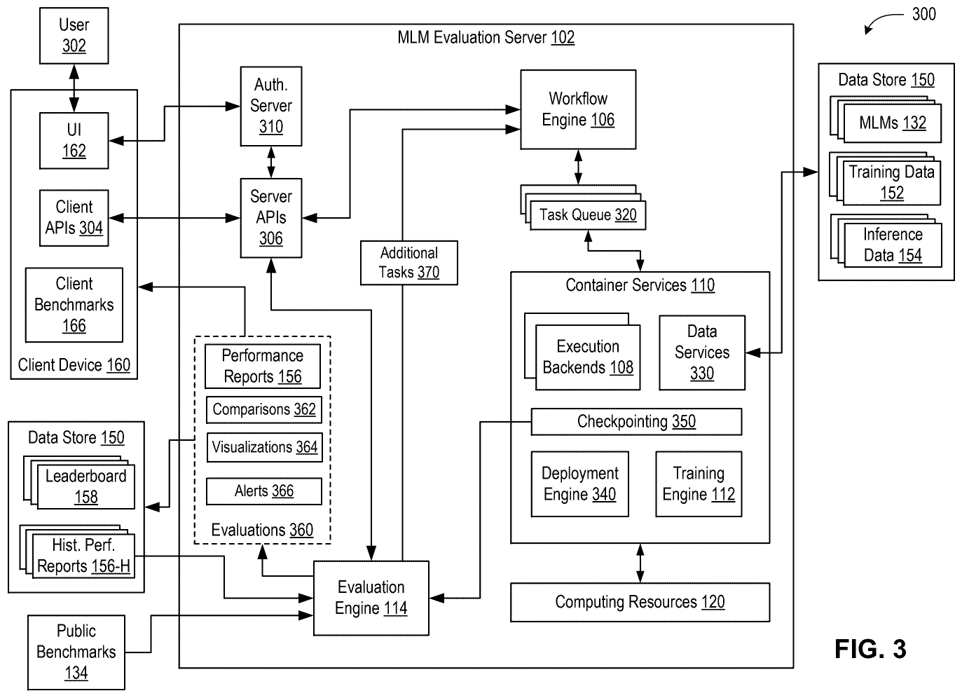

FIG. 3 illustrates schematically operations 300 of a machine learning model evaluation service, according to at least one embodiment. The evaluation service may use MLM evaluation server 102, which may be a cloud-based server, a local machine-based server, or a combination thereof where a portion of operations is performed on a cloud (e.g., task orchestration and container packing) while another portion is performed locally (e.g., container execution). Operations 300 may include receiving one or more user inputs from a user 302 via UI 162, which may include a command line interface, a browser-based interface, a proprietary graphics interface, an open-source graphics interface, and/or any combination thereof. Communications of user 302 and client device 160 MLM and/or further with MLM evaluation server 102 may be supported by one or more client APIs 304, which may include client TDI API 164 (with reference to FIG. 1) that facilitates execution of one or more MLMs and client evaluation API 168 (with further reference to FIG. 1) that may facilitate evaluation of the one or more executed MLMs. Client APIs 304 may be client device counterparts of server APIs 306, which may include a server TDI and a server evaluation API 104 (with reference to FIG. 1), both operating on MLM evaluation server 102.

Access by user 302 to server APIs 306 may be controlled by an authentication server 310. Authentication server 310 may enforce defined access categories and/or user groups, e.g., at organizational level, group level, user level, and/or the like. For example, an administrator of MLM evaluation server 102 may identify access rights for a specific organization (e.g., company, government office, etc.), which may include an amount of processing and memory resources allocated for use by the organization, such as a number of GPUs/CPUs, virtual GPUs/CPUs, units of memory, network bandwidth, and/or the like. Individual organizations may further establish group (team) rights and individual group rights for various members of the organizations. For example, a specific user may be granted up to two GPU during peak hours and up to four GPUs during off-peak hours. In some embodiments, user 302 may have unlimited (clastic) access to computational resources of the evaluation service that is scaled up (and down) as necessary depending on the number and complexity of tasks executed by user 302. Authentication server 310 may enforce access rights of various users, teams, organizations, and the like, using passwords, cryptographic encryption, digital authentication, and/or other suitable techniques of data protection. For example, while pre-trained models may be accessible to multiple users/groups of users, models that are trained on user's data may be protected by authentication server 310 from unauthorized accesses by other users/groups. Similarly protected may be various user's data, including training data, training hyperparameters, training/optimizing/deployment logs, data generated by deployed models, and/or the like.

Inputs from user 302 may be delivered to MLM evaluation server 102 via a number of API commands supported by client APIs 304/server APIs 306 including but not limited to TRAIN command, PRUNE command, QUANTIZE command, EXPORT command, AUGMENT command, INFER command, EVALUATE command, and/or any other suitable commands as may be defined by the APIs and supported by workflow engine 106, training engine 112, deployment engine 340, and/or evaluation engine 114.

Inputs from user 302 may identify user data, which may be stored in data store 150 on user's storage space (or workspace) or on client device 160. In some embodiments, data store 150 may be maintained by a provider different from a provider of MLM evaluation server 102. In some embodiments, data store 150 may store one or more MLMs 132 at various stages of training, optimization, or deployment, e.g., pre-trained MLMs, fine-tuned MLMs, pruned/quantized MLMs, MLMs optimized for execution on a particular set of computing resources, and/or the like. Data store 150 may further store training data 152 capable of being used for MLM training, testing, optimization, etc. tasks, and/or inference data 154 for processing by trained and deployed MLMs. Data store 150 may include any suitable user cloud storage, including public cloud storage, private cloud storage, hybrid cloud storage, community cloud storage, and/or the like. Data store 150 may include a file storage, a block storage, an object storage, and/or the like.

In some implementations, user 302 may communicate, via client APIs 304, one or more addresses (e.g., URL addresses or internal data store addresses) where MLM(s) 132 and/or various data are stored and any suitable authentication credentials (e.g., usernames, passwords, password hashes, etc.), and the MLM evaluation server 102 may automatically access and download the stored content from data store 150.

Client APIs 304 may allow user 302 to send requests to workflow engine 106 to handle various jobs including requests to list, create, update, delete, execute jobs, retrieve status of jobs, upload and download data, and/or the like. Workflow engine 106 may receive commands (requests) generated by client APIs 304 and may implement functionality requested by user 302 as a series of one or more tasks or jobs. A task (job) can be any unit of computing work that the workflow engine 106 identifies and schedules for execution on computing resources 120 (e.g., a set of available GPU(s), CPU(s), memory devices, and/or the like, as described in conjunction with FIG. 1 and FIG. 2). A task may be executed by processing devices subject to instructions of any suitable software program, including one or more execution backends 108.

Tasks scheduled and orchestrated by workflow engine 106 may be related to training models (e.g., MLMs 132), optimizing models, deploying models, using models for inference processing, evaluating models' performance during training and/or inference. Different tasks may have different compute/memory requirements and may be scheduled for execution on different sets of computing resources 120. Some tasks may be executed on multiple GPUs and/or CPUs.

In some implementations, workflow engine 106 may be or include Slurm Workload Manager (also formerly known as Simple Linux Utility for Resource Management, or SLURM) for managing and orchestrating execution of parallel tasks/jobs. Workflow engine 106 may form and maintain a task queue 320 for execution of tasks using one or more execution backends 108, e.g., TensorFlow®, PyTorch®, TensorRT®, ONNX®, Keras®, and/or other similar backends. Execution of tasks may be facilitated by one or more libraries (not shown in FIG. 3), e.g., loss function libraries to evaluate errors in training, learning rate schedulers to adjusts the learning rate between training epochs (iterations), pruning libraries to eliminate inefficient neurons as part of MLM optimization, augmentation libraries to generate variations in training data, annotation libraries to perform automated annotation of training data, various evaluation libraries to evaluate trained MLMs, and/or any other suitable libraries.

MLM evaluation server 102 may deploy training engine 112 for facilitating and performing various tasks associated with training of MLMs using suitable sets of hyperparameters. Hyperparameters may include a learning rate, a regularization constant, parameters of gradient descent, a number of training epochs, a number of branches in a decision tree, a number of clusters in a clustering algorithm, and/or the like. In some embodiments, user 302 may specify target ranges for any, some, or all hyperparameters, e.g., minimum and maximum learning rates used in training of specific MLMs. In some implementations, training engine 112 may run multiple experiments, e.g., training (or fine-tuning) a particular MLM using different sets of training data 152, e.g., in parallel, to distinguish sets that are more effective in training the MLM for a target task from less effective sets, e.g., using evaluation engine 114 as disclosed in more detail below, and provide reports to user 302 about relative effectiveness of various sets of training data 152.

In some implementations, workflow engine 106 may estimate a number of computational operations required to execute jobs associated with user's tasks, such as a number of GPU and/or CPU clock cycles, memory reads/writes, etc., and allocate a corresponding number and type of computing resources 120 for efficient (e.g., latency-free or low latency) execution of the jobs. In some instances, the number and type of resources allocated by workflow engine 106 may be explicitly specified by user 302.

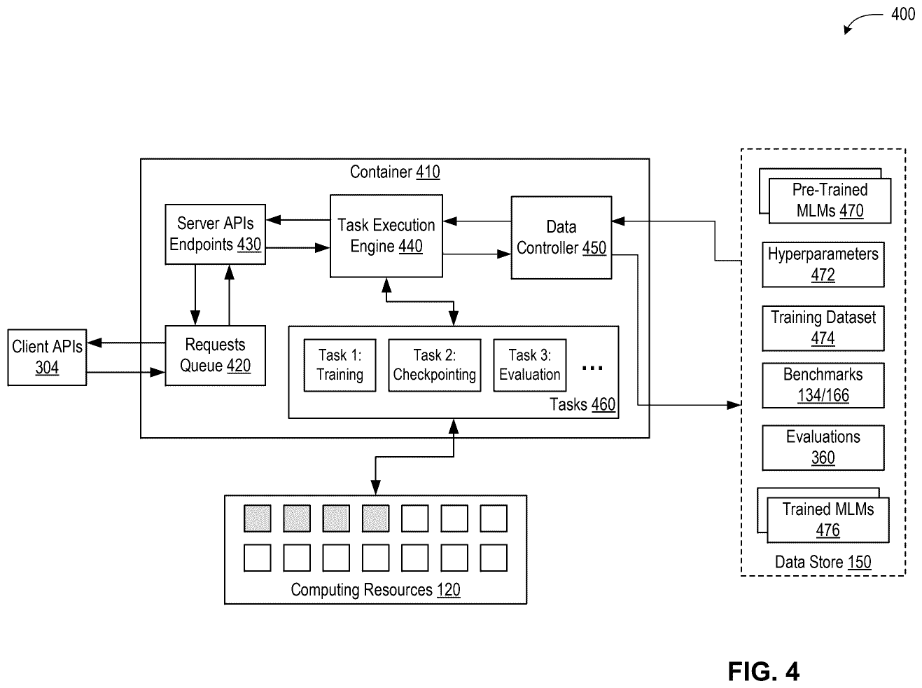

In some embodiments, to execute the user's tasks, workflow engine 106 may instantiate one or more containers supported by container services 110, e.g., Kubernetes containers, DOCKER containers, and/or the like. Execution of containers is illustrated in more detail in conjunction with FIG. 4 below. User's tasks may be assigned to one or more execution backends 108, which may be capable of training, evaluating, optimizing, deploying for inference, etc., one or more MLMs 132. In some instances, the types of MLI backends (e.g., TensorFlow®, PyTorch®, TensorRT®, ONNX®, Keras®, and/or the like) may be selected by user 302. In other instances, workflow engine 106 may select execution backend(s) 108 without a user input, e.g., if user 302 is inexperienced and/or has no preference. For example, the backend selection may be performed based on the type of MLM(s) 132 selected by user 302, the format of data (e.g., training data 152 and/or inference data 154) to be used with the MLM(s) 132, and/or the like. For example, workflow engine 106 may use one or more default execution backends 108 for medical imaging models, speech recognition models, text recognition models, physical/chemical sensor models, and so on. In some embodiments, default execution backends 108 may be set by an administrator of MLM evaluation server 102. In some embodiments, default execution backends may be set (or modified) by user 302.

Deployment engine 340 may format various tasks scheduled by workflow engine 106 for execution on trained MLMs, including optimizing models, pruning models, quantizing models, e.g., from a 32-bit floating-point (FP) format to a 16-bit, 8-bit, 4-bit FP format or to an integer number format. Deployment engine 340 may further configure one or more trained MLMs for execution on a computer system that is different from MLM evaluation server 102, e.g., directly on client device 160 or some other system under control of user 302, which may be a system with fewer resources than MLM evaluation server 102.

In some examples, deployment engine 340 may package MLM(s) 132 as a microservice, e.g., an inference microservice (such as NVIDIA NIMs), which may include an API layer, a server layer, a runtime layer, and/or a model layer (e.g., weights and biases). In some instances, such as where the MLM(s) has a small enough number of parameters, the MLM(s) may be included within a container instantiated by container services 110. In other examples, such as where the MLM(s) is large, the MLM(s) may be hosted/stored in the cloud (e.g., in a data center) and/or may be accessible via one or more APIs, such as REST APIs.

Data services 330 may perform any suitable operations on training data 152 and/or inference data 154, including but not limited to pre-processing the data (e.g., de-noising data, reformatting data, filtering data, and/or the like), annotating the data (e.g., using open vocabulary model(s) and/or other trained models capable of automatically identifying target content in the data), verifying correctness of the data (e.g., checking the format(s) of the data and/or data annotations), and/or the like.

In some embodiments, workflow engine 106 may schedule one task per container instantiated by container services 110, e.g., MLM training or deployment. In other instances, a container may include an entire pipeline of tasks, starting from pre-processing and annotating training data 152, using one or more execution backends 108 to fine-tune a number of user-selected pre-trained MLMs 132, optimize the fine-tuned MLMs for execution on a suitable device (e.g., client device 160), re-train the optimized MLMs (if indicated by evaluation results), and storing the MLMs on data store 150, client device 160 or some other user space.

In some embodiments, training engine 112 or deployment engine 340 may perform checkpointing 350, which may include stopping training of an MLM, e.g., after completing a predetermined number of training epochs, or pausing inference computations after processing a predetermined number of batches of inference data. Checkpointing 350 may include storing a current state of the MLM, e.g., model parameters (weights and biases of various neurons of the MLM) of the MLM after completion of the training epoch(s). Checkpointing 350 may further include storing a current state of training, including hyperparameters (e.g., learning rate), state of iteration counter, type of optimizer, including (but not limited to) gradient descent, stochastic gradient descent, adaptive moment estimation (ADAM), root mean square propagation, and/or the like. The state of training may also include MLM outputs generated in response to various training inputs, e.g., various training, fine-tuning, and/or inference prompts.

Evaluation engine 114 may access and load various evaluation benchmarks, which may include public benchmarks 134 and/or any suitable set of (proprietary) client benchmarks 166. For example, public benchmarks 134 may include LM Evaluation Harness for quantifying performance of LLMs, MT-Bench for measuring ability of LLMs to engage in human-like conversations, GARAK (Generative AI Red-teaming and Assessment Kit) for identifying weaknesses and potential vulnerabilities of LLMs, BigCodeBench for determining coding capabilities of LLMs, and/or other suitable benchmarks. Client benchmarks 166 may include any set of performance-measuring tools created by the user, an organization associated with the user, and/or tools created at the direction of the user/organization. Client benchmarks 166 may include or operate in conjunction with any suitable sets of (public or proprietary) evaluation data. In some implementations, evaluation engine 114 may be executed within a container instantiated by container services 110. In some implementations, various benchmarks may be loaded directly into a container in which the evaluation engine 114 is deployed. In those instances, where the benchmarks are associated with large volumes of data, data may be stored elsewhere (e.g., on cloud, in a data center, and/or the like) and may be accessible via one or more APIs, e.g., evaluation API (as part of server APIs 306).

Evaluation engine 114 may apply the loaded and/or stored benchmarks to the state of MLM and/or state of MLM training, e.g., stored as part of checkpointing 350, to generate one or more metrics characterizing performance of the MLM(s). The metrics may include accuracy (including precision, recall, F1 score, etc.) of predictions made by the MLM(s), e.g., in those instances of training data 152 and/or inference data 154 for which ground truth is known. The metrics may further include a degree to which the generated responses resemble human language. For example, evaluation engine 114 may deploy a trained discriminator model that ranks (according to a suitable set of grades, e.g., 0, 1, . . . 5) the outputs of an LLM by to a degree of similarity of those outputs to human-generated texts or speech. The metrics may further include a degree of safety of the outputs, a degree of toxicity of outputs, a degree to which the MLM(s) appropriately redact (or, to the contrary, reveal) personally identifiable information.

Various metrics generated by evaluation engine 114 may be combined into a set of evaluations 360 that may be provided to a user 302 (e.g., displayed or otherwise presented, such as read aloud, via UI 162), stored in data store 150 (or some other suitable device), communicated over network 140 (with reference to FIG. 1), and/or handled in some other way.

Evaluations 360 may include performance reports 156, e.g., progress reports indicative of performance of MLM(s) in inference processing or improvement (or lack thereof) of MLM(s) in training. Performance reports 156 may be generated for various units of inference and/or training, e.g., a certain number of processed inference inputs, a certain number of training epochs and/or training data used, a certain period of time elapsed, and/or the like. Performance reports 156 may include various logs associated with inference and training, e.g., correct/incorrect (e.g., binary) classifications and/or predictions for various sets of training data, values of loss functions (which may be non-binary, e.g., continuous value) computed for different training inputs, distributions of weights and biases of the MLM(s), logs of learning rates, and/or any other statistical data.

In some implementations, performance reports 156 may be generated and/or displayed in conjunction with historical performance reports 156-H associated with previous training (including fine-tuning) or inference performance of the same MLM(s) or MLMs of the same or similar type (e.g., speech-to-text processing MLMs), including publicly available MLMs (e.g., free-access or commercial models), MLMs previously evaluated by user 302, organization of the user 302, and/or other public or private users and/or organizations whose evaluations are available to user 302 via historical performance reports 156-H. Performance reports 156 obtained as part of a given evaluation session may be used to update historical performance reports 156-H, e.g., by updating data related to the specific MLMs presently being evaluated, updating data for the technology area of these specific MLMs, and/or the like.

Performance reports 156 for the MLM(s) being currently evaluated may be displayed as comparisons 362 with previously evaluated MLM(s) by the evaluation service of FIG. 3 and/or MLM(s) whose performance has been evaluated (and represented in historical performance reports 156-H) by other entities (private or public). Comparisons 362 may be between metrics collected and evaluated for the same MLM at different stages of training or after processing different sets of training and/or inference data, between metrics collected for different MLMs (including similar MLMs having different architectures, e.g., the number of layers/neurons in the layers) processing the same or similar sets of training and/or inference data, between metrics collected for different training hyperparameters (e.g., learning rate, batch size, and/or the like), and so on. In some embodiments, e.g., where the executed tasks include using a RAG to augment the LLM's knowledge base, comparisons 362 may be between metrics that characterize performance of RAG-assisted LLM operations and metrics that characterize unassisted LLM operations, between performances assisted with different RAG databases and/or the like.

In some implementations, performance reports 156 and/or comparisons 362 may be supplemented by visualizations 364, which may include any graphical representations of performance reports 156 and/or comparisons 362. For example, visualizations 364 of performance reports 156 may include plots, charts, animations, videos, and/or other suitable representations of performance reports 156, e.g., plots of accuracy of MLM outputs for different times (checkpoints), training epochs, and/or input data, plots of learning rates and/or animations of the distributions of weights/biases with passing time/epoch, and/or the like. Visualizations 364 of comparisons 362 may include side-by-side (over-and-under, superimposed, color-coded, and/or the like) plots, histograms, animations, etc., of two or more sets of performance metrics associated with different MLM(s), sets of hyperparameters, sets of training/inference data, and so on.

In some implementations, obtaining performance reports 156, visualizations 364, and/or comparisons 362 may include uploading the state of MLM(s) and/or training state of MLM(s) to a third-party server (e.g., “Weights & Biases” service, “ClearML” service, and/or the like).

The obtained metrics may be used to generate alerts 366. For example, metrics generated by evaluation engine 114 may indicate that one or more threshold conditions are satisfied or not satisfied by the training or inference performance of the MLM(s). Correspondingly, evaluation engine 114 may generate and communicate alerts 366 to user 302 via server APIs 306/client APIs 304 (e.g., the evaluation API) to be displayed on UI 162. For example, evaluation engine 114 may determine that the metrics indicate that an MLM has achieved a target performance, e.g., a certain accuracy (precision, recall, F1 score, a degree of resemblance to human-generated text/speech, and/or the like) and issue a positive alert 366 to user 302. In another example, evaluation engine 114 may determine that the improvement of the MLM caused by the task being executed (e.g., training using a particular set of training data and/or hyperparameters) has not resulted in a minimum acceptable target improvement and may issue a negative alert 366 to inform user 302 of inefficiencies in the training process and/or training data.

Various evaluations 360 may be used to generate suitable leaderboards 158 that can also be provided to user 302 via UI 162 and/or stored in data store 150. Leaderboards 158 may include rankings of various MLMs whose evaluation has been performed by evaluation engine 114 and/or made accessible to evaluation engine 114 (e.g., via historical performance reports 156-H, evaluations of models performed and published by other services not affiliated with the service running evaluation engine 114. For example, leaderboards 158 may rank MLM(s) by accuracy (including precision, recall, F1 score, etc.), quality (e.g., human-like generative content), speed of processing, and/or the like. Leaderboard 158 may also rank various training data 152 by the effectiveness in training of MLM(s), including the speed of MLM training with individual sets of training data (e.g., a number of training epochs and/or hours of training before achieving a target proficiency), quality of training (e.g., as determined from accuracy and/or quality of MLM outputs achieved after training of MLMs using respective sets of training data), and/or the like. Leaderboards 158 may include rankings for a given domain (e.g., chatbot models, speech-to-text models, text-to-speech models, VLMs, MMLMs, objects detection/tracking models, and so on). Leaderboards 158 may also include rankings for a given model architecture (e.g., convolutional models, transformer models, long short-term memory models, and/or the like). Leaderboards 158 may include rankings for various publicly available training datasets (including open-source datasets), for synthetic datasets, augmented datasets, and/or any other suitable training datasets.

In response to receiving any or some of performance reports 156 (including historical performance reports 156-H), comparisons 362, visualizations 364, alerts 366, and/or other suitable evaluations 360, user 302 may review and change some of the tasks executed by workflow engine 106. For example, user 302 may change hyperparameters used by training engine 112 (e.g., increase or decrease the learning rate, etc.), replace training data 152 or select additional training data, and/or the like. In some instances, user 302 may determine that training of one or more MLMs has achieved a target performance and may stop further training and deploy the MLM(s) for inference processing, e.g., in customer-facing applications. In some instances, user 302 may stop training of one or more MLMs upon determining that further training is unlikely to achieve a minimum acceptable performance and initiate training of one or more different MLMs, e.g., models with a different architecture, such as number of neurons and/or topology of neural connections. In some instances, user 302 may apply a different set of client benchmarks 166 and/or public benchmarks 134 to previously evaluated MLM(s). To implement these and other changes, user 302 may access task queue 320 (whose suitable text or graphics representation may be provided on UI 162 via client APIs 304) and terminate or add any number of tasks to be performed by training engine 112, deployment engine 340, evaluation engine 114, and/or other modules and components of the evaluation service.

In some embodiments, the evaluation engine 114 may automatically stop tasks being executed or execute additional tasks 370 in view of the obtained evaluation metrics, including making any, some or all changes that user 302 can make, as described above. In such instances, evaluation engine 114 may direct workflow engine 106 to format, orchestrate (e.g., split into sub-tasks and/or ensure that various task dependencies and prerequisites are satisfied), and place additional tasks 370 in task queue 320. Additional tasks 370 may include continuing training of one or more MLMs with additional or new training data, advancing the training to the next, e.g., more specialized, stage (e.g., from foundational LLM training to training in a specific field of knowledge), concluding the training and deploying the MLMs for inference use, and/or the like. In some instances, the evaluation engine 114 may determine, in view of the obtained metrics, that the execution of the current training has resulted in a decrease of skills previously learned by the MLM(s). Evaluation engine may then automatically schedule refreshing of these previously learned and regressed skills using a suitable set of training data 152, and/or recommend such refresher training to user 302.

FIG. 4 illustrates schematically an example container-based execution 400 of evaluation of training of MLMs, according to at least one embodiment. Container-based execution 400 may include instantiating a secure container 410, which may be a Kubernetes container, a DOCKER container, an NVIDIA NIM container, and/or the like. A set of requests from a user, received via client APIs 304, may include any number of tasks, e.g., MLM training and evaluation tasks. Although, for the sake of concreteness FIG. 4 illustrates operations performed in the context of training, similar operations may be performed for evaluation of inference operations. Tasks may be scheduled by workflow engine 106 of FIG. 3 (not shown in FIG. 4), which may group tasks into logical groups, individual groups executed in separate containers 410. In some instances, tasks associated with different MLMs may be executed in different containers while tasks related to the same MLM (e.g., fine-tuning, evaluation, and deployment of the same MLM) may be grouped into a single container. In some instances, an advanced user may select how different tasks are to be distributed among the containers. In other instances, e.g., when a user has no preferences (or lacks sufficient experience to make an informed selection), the workflow engine may automatically determine the optimal number of containers and distribute tasks among the containers, e.g., to maximize computational efficiency, speed of processing, reduce latency, and/or the like. For example, tasks that have to be processed sequentially may be grouped into a single container while unrelated tasks that can be processed in parallel may be distributed among multiple containers.

Requests from client APIs 304 may form a requests queue 420 that is received by server APIs endpoints 430. Server APIs endpoints 430 may communicate with the workflow engine that allocates tasks to the container 410. Execution of the tasks assigned to the container may be orchestrated by a task execution engine 440. The user may provide names and/or addresses for one or more models, e.g., pre-trained MLMs 470 stored in a suitable data store, e.g., data store 150. The user may further provide hyperparameters 472, e.g., via a JSON file, which may be located on data store 150 or, in some embodiments, directly selected and uploaded via client APIs 304. The user may further specify one or more addresses of a training dataset 474 to be used for training or fine-tuning of one or more pre-trained MLMs 470. Training dataset 474 may be provided by specifying a cloud/local storage address where the dataset is stored or by uploading data from a client device (e.g., where proprietary user's data may be stored). A data controller 450 may fetch any, some, or all of the pre-trained MLM(s) 470, hyperparameters 472, and/or training dataset 474 from data store 150. Task execution engine 440 may initialize one or more tasks 460 on a selected (indicated with shaded squares) configuration of one or more resources computing resources 120, e.g., processors and memory devices allocated or otherwise accessible to container 410.

Tasks 460 may include training task(s) (task 1), checkpointing task(s) (task 2), evaluation task(s) (task 3), and/or any other suitable tasks (e.g., inference tasks). The training task(s) may train (or fine-tune) one or more pretrained MLMs 470 using training dataset 474 provided or specified by the user. For example, an MLM may be pre-trained using a basic set of images as a general-purpose object recognition model. Using a TRAIN command supported by the client APIs 304, the user may specify training dataset 474 and/or one or more hyperparameters 472 to further train the MLM as a domain-specific model, e.g., as a medical image object recognition model. Hyperparameters 472 may be specific to a particular MLM architecture and/or type. For example, object recognition models, speech recognition models, speech synthesis models, conversational models, etc., may have different default hyperparameters.

In one example, a user may request fine-tuning and evaluation of one of one of pre-trained MLMs 470. The user may specify, using an API-supported set of commands (e.g., TRAIN, DATASET, EVALUATE, etc.) a training dataset 474 and hyperparameters 472 to be used for fine-tuning of the MLM and may further specify a suitable set of benchmarks 134/166 for evaluation of the MLM. Following instantiation of the container 410, the task execution engine 440 may format and initiate training, checkpointing, and evaluation tasks. The training task may implement the functionality of the training engine 112 (with reference to FIG. 3), including preparing and inputting training data into the MLM, receiving outputs of the MLM, comparing the outputs of the MLMs with ground truth using a suitable loss function, backpropagating the loss through various blocks and neurons of the MLM based on a user-specified learning rate or a learning rate selected automatically by the training task. The checkpointing task may pause the training after a certain number of training inputs and store the state of the MLM and the state of the MLM training. The evaluation task may implement the functionality of the evaluation engine 114 (with reference to FIG. 3), including processing the state of training/state of MLM using the selected benchmarks and generating various evaluations, e.g., as disclosed in conjunction with FIG. 3. The task execution engine 440 may allocate a suitable amount of computing resources 120 (number of processing units and memory) as may be effectively used by the individual tasks. After training, trained MLMs 476 may be stored in data store 150.

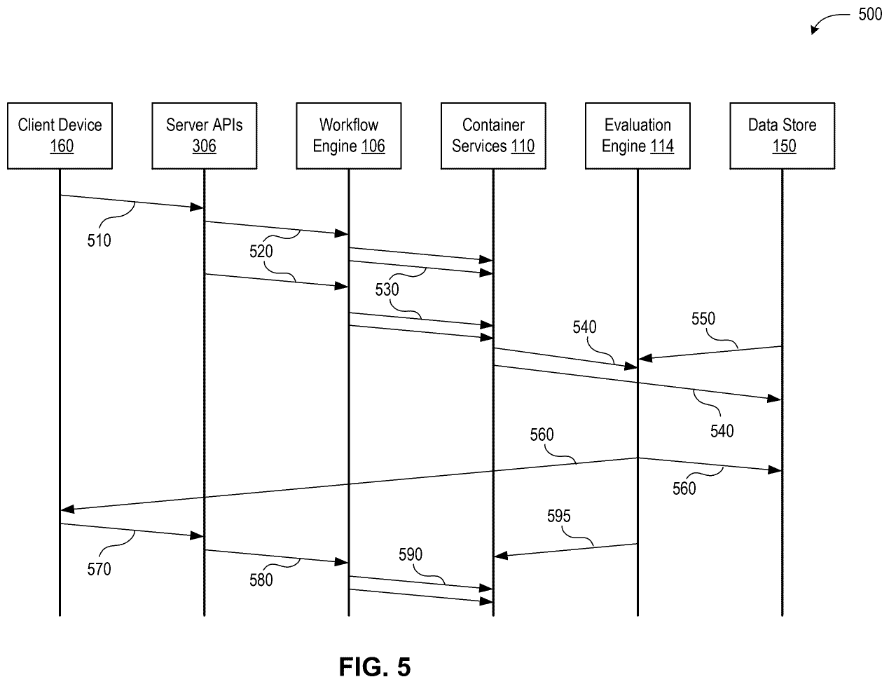

FIG. 5 illustrates schematically a flow of events 500 during training, inference, and evaluation of MLMs, according to at least one embodiment. In one embodiment, as illustrated in FIG. 5, a client device 160 (via one or more client APIs) may receive one or more user's requests 510 for MLM tasks to be executed by the evaluation service. The request can be for training of one or more MLMs, fine-tuning one or more MLMs, exporting one or more MLMs, deploying one or more MLMs, performing inference using one or more MLMs, and/or the like. The client device 160 may forward the requests 510 to the server APIs 306, which may parse the requests 510 into one or more instructions 520 that are communicated to the workflow engine 106. Workflow engine 106 may determine a number of containers, each container to be used for execution of one or multiple individual tasks 530, and may further allocate appropriate computing resources for task execution on container services 110. The container services 110 may allocate the identified resources and instantiate the container(s). The container(s) may execute target tasks, e.g., MLM training, fine-tuning, inference, and/or the like. The data 540 generated by the container(s), e.g., state of MLM(s)/training of MLM(s), and collected as part of checkpointing, may be provided to evaluation engine 114. The data 540 may also be stored in data store 150. Various data 550 (e.g., historical performance reports, evaluation benchmarks, and/or the like) may be downloaded from data store by evaluation engine 114. In other embodiments, evaluation engine 114 may upload data 540 to an external server (not shown in FIG. 5) that applies evaluation benchmarks to data 540.

Evaluations 560 generated by evaluation engine 114 may be reported to the client device 160 (e.g., via the client APIs) and/or stored in the data store 150 (or on a user cloud workspace). Subsequently, the user may make additional requests 570 to modify any part of training, inference, and/or evaluation of MLM(s). Requests 570 may be converted to instructions 580 by server APIs 306 and implemented as additional tasks 590. In some implementations, evaluation engine 114 may automatically generate additional tasks using corresponding instructions 595. After completion of task execution and MLM evaluation, reporting and storing states of MLM/MLM training, the computing resources may be deallocated and the instantiated containers may then be deleted to ensure privacy and security of sensitive user data.

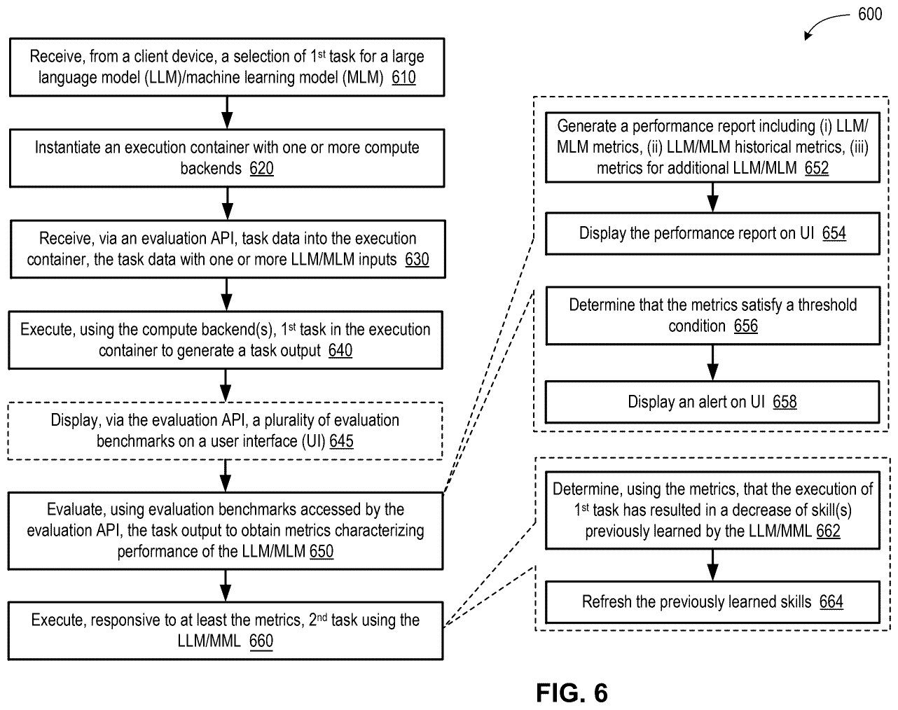

FIG. 6 is a flow diagram of an example method 600 of performing evaluation of one or more MLMs, in accordance with at least some embodiments. FIG. 6 may be used to perform evaluations of any suitable operations associated with one or more MLMs (e.g., training, fine-tuning, adapting, optimizing, deploying, etc.) and/or using various sets of training data for training one or more MLMs. Method 600 may be performed in conjunction with MLMs used in voice recognition, speech recognition, speech synthesis, object detection, object recognition, motion detection, hazard detection, robotics applications, forecasting, language models (including large language models), and any other contexts and applications where machine learning may be used. In at least one embodiment, method 600 may be performed by processing units (e.g., GPUs, CPUs, etc.) of MLM evaluation server 102 (with reference to FIG. 1 or FIG. 3) or processing units of some other computing device, or a combination of multiple computing devices. The one or more processing units may include (or communicate with) one or more memory devices. In at least one embodiment, method 600 may be performed by multiple processing threads (e.g., CPU threads and/or GPU threads), individual threads executing one or more functions, routines, subroutines, or operations of the method. In at least one embodiment, processing threads implementing method 600 may be synchronized, e.g., using semaphores, critical sections, and/or other thread synchronization mechanisms. Alternatively, processing threads implementing method 600 may be executed asynchronously with respect to each other. Various operations of method 600 may be performed in a different order compared with the order shown in FIG. 6. Some operations of the method may be performed concurrently with other operations. In at least one embodiment, one or more operations shown in FIG. 6 may not always be performed. Although for brevity and conciseness, the description below references a single MLM, operations of method 600 may similarly be performed in conjunction with multiple MLMs.

At block 610, processing units performing method 600 may receive, from a client device, a selection of a first task for a large language model (LLM) or an MLM of some other type. At block 620, method 600 may continue with the processing units instantiating an execution container, the container including one or more compute backends. The one or more compute backends may include TensorFlow® backend, PyTorch® backend, TensorRT® backend, ONNX® backend, Keras® backend, and/or the like.

At block 630, method 600 may continue with the processing units receiving, via an evaluation API (e.g., client evaluation API 168, server evaluation API 104, or both), task data into the execution container (e.g., container 410 in FIG. 4). The task data may include one or more LLM prompts or one or more inputs into the MLM. In some implementations, the first task for the LLM/MLM includes training the LLM/MLM using the task data, fine-tuning the LLM/MLM using the task data, performing inference processing of the task data using the LLM/MLM, and/or the like. In some implementations, the task data may include retrieval augmentation database (RAG) data.

At block 640, operations of method 600 may continue with the processing units executing, using the one or more compute backends, the first task in the execution container to generate a task output. The task may include one or more responses, generated by the LLM/MLM, to the one or more LLM prompts (or other MLM inputs) of the task data (e.g., one or more inference responses to prompts received by a customer-facing chatbot) or a modification of one or more parameters of the LLM/MLM based at least on the one or more LLM prompts of the task data (e.g., changes to the parameters of the LLM/MLM made based on a comparison of the response(s) with ground truth for the LLM prompts/MLM inputs).

In some implementations, at block 645, method 600 may include displaying, via the evaluation API, a plurality of evaluation benchmarks on a user interface (e.g., UI 162 in FIG. 1 and FIG. 3). The one or more evaluation benchmarks may be selected based on a user selection of the one or more evaluation benchmarks from the plurality of evaluation benchmarks or a default selection of the one or more evaluation benchmarks from the plurality of evaluation benchmarks. In some implementations, the default selection may be based on a type of the first task (e.g., LLM, speech MLM, object detection MLM, and/or the like), a type of the task data (e.g., text, images/videos, audio, sensor data, and/or the like). In some implementations, the plurality of evaluation benchmarks may include one or more public (e.g., open-source or commercial) evaluation benchmarks and/or one or more proprietary evaluation benchmarks accessible to the client device (e.g., evaluation benchmarks developed by the user or the user's organization).

At block 650, method 600 may continue with the processing units evaluating, using one or more evaluation benchmarks accessed by the evaluation API, the task output to obtain one or more metrics characterizing performance of the LLM/MLM. In some implementations, e.g., where an LLM is using RAG data, the one or more metrics may include metrics characterizing performance of the LLM operating in conjunction with the RAG data, e.g., accuracy and/or quality of LLM responses with and without the use of the RAG data.

In some implementations, operations of block 650 may include one or more operations illustrated with the top callout portion in FIG. 6. More specifically, at block 652, the processing units executing method 600 may generate an LLM/MLM performance report, which may include the one or more obtained metrics and may further include one or more historical metrics characterizing past performance of the LLM/MLM and/or one or more additional metrics characterizing performance of at least one additional LLM/MLM different from the LLM/MLM. At block 654, method 600 may include displaying, via the evaluation API, the LLM/MLM performance report on the UI.

In some implementations, method 600 may also include, at block 656, determining a correspondence of the one or more metrics to a threshold condition, e.g., whether accuracy or quality of LLM/MLM responses is below, at. or above a target performance. At block 658, method 600 may continue with displaying on the UI, responsive to the determined correspondence, an alert that the LLM/MLM has achieved a target performance or an alert that an improvement of the LLM/MLM caused by the execution of the first task is below a target improvement (e.g., the LLM/MLM is not learning or learning at an insufficient rate).

At block 660, method 600 may continue with the processing units executing, responsive to at least the one or more metrics, a second task using the LLM/MLM. For example, the training of the LLM/MLM may continue with the user selecting additional or different training data, changing learning rate, changing architecture of the LLM/MLM (e.g., adding or removing neurons), and/or performing any combination thereof as part of the second task. In another example, the first task may be (or include) training or fine-tuning the LLM/MLM and the second task may be (or include) deploying the LLM/MLM for inference processing.

In some implementations, executing the second task may include one or more operations illustrated with the bottom callout portion in FIG. 6. More specifically, at block 662, method 600 may include determining, using the one or more metrics, that the execution of the first task has resulted in a decrease of one or more skills previously learned by the LLM/MLM. At block 664, method 600 may continue with refreshing the one or more skills previously learned by the LLM/MLM (e.g., using one or more sets of re-learning or re-calibration training data).

In some implementations, operations of method 600 may be used to compare effectiveness of different datasets for training models to perform target tasks. More specifically, the task data received at block 630 may include a first data and a second (third, etc.) data, e.g., with both the first data and the second (third, etc.) data being the training data to teach the LLM/MLM to perform any suitable target task (e.g., convert speech to text, convert text to speech, recognize objects, perform facial animation, support a conversation with a human, and/or the like). In such implementations, executing the first task at block 640 may include processing, using the LLM/MLM, the first (second, etc.) data to obtain a first (second, etc.) output for the task. For example, the first (second, etc.) output may include the outcome of training of the LLM/MLM using the first (second, etc.) data, including modifications of parameters of the LLM/MLM caused by the first (second, etc.) data, e.g., as part of experiments performed in parallel (or as any other suitable sequence). In such embodiments, evaluating the task output at block 650 may include obtaining a comparison of the first output to the second (third, etc.) output and generating, based on at least the obtained comparison, a task data performance report for the first data and the second (third, etc.) data. In such embodiments, executing the second task at block 660 may include selecting the version of the LLM/MLM trained with more effective data as the current working version and continuing training of the LLM/MLM from that working version. In those instances where the working version of LLM/MLM is determined to have satisfied a target performance condition (e.g., meet a target threshold), the second task may be (or include) deploying the working version for inference processing and/or processing inference data (e.g., data not encountered by the LLM/MLM in training).

The systems and methods described herein may be used for a variety of purposes, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, augmented reality (AR), virtual reality (VR), mixed reality (MR), robotics, security and surveillance (e.g., in a smart cities embodiment), autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems for performing medical operations, systems for performing factory operations, systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models—such as one or more large language models (LLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

In some examples, the machine learning model(s) (e.g., deep neural networks, language models, LLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

In some embodiments, the system and methods described herein may be deployed in a talking or smart kiosk application. For example, a kiosk, tablet, smart display, or other device may include one or more onboard processors (e.g., CPUs, GPUs, deep learning accelerators, SoCs) and memory and/or storage (e.g., for storing the model, the image database, etc.). In some embodiments, the kiosk/tablet/display may communicate (e.g., using one or more network interface cards (NICs) and/or data processing units (DPUs)) with one or more locally hosted servers/computing devices and/or with one or more remotely located servers/computing devices (e.g., in one or more data centers). In such examples, the kiosk may communicate with the machine learning model(s) (e.g., language model, LLM, VLM, MMLM, diffusion model, transformer model, NeRF, DNN, etc.) and/or the image database hosted on the local and/or remote servers using one or more APIs—such as, without limitation, REST APIs.

In one or more embodiments, the system and methods described herein may be deployed in a gaming application. For example, a gaming console, PC, tablet, or other gaming device may include one or more onboard and/or remote processors (e.g., CPUs, GPUs, deep learning accelerators, SoCs) and memory and/or storage (e.g., for storing the game model, game assets, player data, etc.). These devices may use one or more machine learning models (e.g., diffusion models, transformer models, neural rendering field (NeRF) models, language models (e.g., LLMs, VLMs, MMLMs, etc.), DNNs, etc.) to enhance gameplay, generate real-time dynamic content, and personalize user experiences based on in-game behavior or pre-stored player profiles. In some embodiments, the system may be deployed in a cloud gaming environment (e.g., NVIDIA's GEFORCE NOW). In such cases, a client device (e.g., a smart display, tablet, or gaming controller) may be used to interact with the game, while the machine learning model(s) and/or visual rendering may occur on one or more remotely located servers/computing devices (e.g., in one or more data centers). The language model, AI processing, and rendering described herein may operate in the cloud, processing player inputs received from an end-user device(s) (e.g., based on controller, keyboard, mouse, joystick, AR/VR/MR/etc. inputs), generating appropriate in-game responses, rendering the content, and sending or transmitting the content to the end-user device(s). During receiving and/or sending the data to and from the end-user or edge device(s), one or more data processing units (DPUs) and/or network interface cards (NICs) may be used.

In some embodiments, the system and methods described herein may be deployed in a video conferencing application. For example, a video conferencing device, such as a dedicated conferencing unit, computer, tablet, and/or smartphone, may include one or more onboard processors (e.g., CPUs, GPUs, deep learning accelerators, SoCs) and memory and/or storage (e.g., for storing the video, audio, or other communication-related data). The system may use the machine learning model(s) (e.g., diffusion models, transformer models, neural rendering field (NeRF) models, language models (e.g., LLMs, VLMs, MMLMs, etc.)) to enhance video conferencing functionality, including real-time or near real-time transcription, diarization, language translation, automatic speech recognition (ASR), and/or background noise reduction. In one or more embodiments, the system may enable users to interact with the video conferencing platform using natural language inputs. For example, users may issue voice commands to schedule, join, or leave meetings, or to manage participants and screen sharing. During receiving and/or sending the data to and from the end-user or edge device(s), one or more data processing units (DPUs) and/or network interface cards (NICs) may be used.

In some embodiments, the system and methods described herein may be deployed in a robotics application. For example, a robot or robotic system may include one or more onboard processors (e.g., CPUs, GPUs, hardware-based deep learning accelerators (DLAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). The robotic system may use these processors to execute one or more machine learning models (e.g., language models) that allow it to perform complex tasks autonomously or semi-autonomously, such as interacting with and/or manipulating static and/or dynamic objects, or navigating environments using sensors such as cameras, LiDAR, RADAR, ultrasonic sensors, and more. The system may use sensor fusion techniques to combine data from multiple sensors (e.g., cameras, infrared, LiDAR, RADAR, accelerometers) to create a comprehensive model of the robot's surroundings. This data may be processed locally on the robot or sent to remote servers for more computationally intensive tasks, such as 3D mapping or SLAM (Simultaneous Localization and Mapping). In one or more embodiments, data from individual robots (e.g., sensor data, task status, or environmental conditions) may be uploaded to the cloud, where centralized AI models can analyze and distribute optimized commands to an entire fleet. In some embodiments, the machine learning model(s) (e.g., language models, VLMs, LLMs, MMLMs, diffusion models, NeRF models, DNNs, etc.) described herein may be used to allow the robot to perceive and reason about the environment and/or communicate with one or more other robots and/or persons in an environment. In some embodiments, the robot may communicate (e.g., using one or more network interface cards (NICs) and/or data processing units (DPUs)) with one or more locally hosted servers/computing devices and/or with one or more remotely located servers/computing devices (e.g., in one or more data centers).

In some embodiments, the system and methods described herein may be deployed in an in-vehicle infotainment (IVI) system or in-cabin experience (IX) application. For example, the infotainment system within a vehicle (e.g., cars, trucks, drones, construction equipment, robots, semi-autonomous vehicles, or autonomous vehicles) may include one or more onboard processors (e.g., CPUs, GPUs, hardware-based deep learning accelerators (DLAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). and memory and/or storage (e.g., for storing entertainment content, navigation data, and user preferences). The system may use these processors to execute one or more machine learning models (e.g., language models) to enable features such as voice control, personalized media recommendations, dynamic navigation, and real-time communication with other services through network connectivity. The in-vehicle infotainment system may also use natural language processing (NLP) models to enable voice-based interaction. The one or more machine learning models may be stored locally or accessed through one or more APIs that connect to cloud services, enabling the system to process requests in real time or near real-time.

Although examples may be described herein with respect to using machine learning models, such as neural networks, this is not intended to be limiting. For example, and without limitation, any of the various machine learning models and/or neural networks described herein may include any type of machine learning model, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoder neural networks, artificial neural networks (ANNs), convolutional neural networks (CNNs), recurrent neural networks (RNNs), perceptrons, Long/Short Term Memory (LSTM) networks, multi-layer perceptron (MLP) networks, deep stacking networks (DSNs), generative pre-training (GPT) models or networks, feed forward networks, radial basis function ANNs, self-organizing maps (SOMs), Kohonen maps, Hopfield networks, Boltzmann machine, deep belief neural networks, deconvolutional neural networks, generative adversarial networks (GANs), liquid state machines, modular neural networks, liquid state machines, sequence-to-sequence models, networks using transformer architectures, diffusion models (e.g., diffusion probabilistic models, score-based generative models, etc.), neural rendering field (NeRF) models, Kolmogorov-Arnold networks (KANs), models with encoder-only architectures, models with decoder-only architectures, models with encoder-decoder architectures, generative machine learning models, language models, large language models (LLMs), vision language models (VLMs), multi-modal language models (MMLMs), etc.), and/or other types of machine learning models.

In some embodiments, one or more transformer engines (TEs) may be implemented. The transformer engine may use micro-tensor scaling to optimize performance and accuracy—such as to enable 16-bit floating point (FP16), 8-bit floating point (FP8), and/or 4-bit floating point (FP4) artificial intelligence processing. For example, the transformer engine may use 16-bit or 8-bit floating point precision and an 8-bit or 4-bit floating point data format combined with software algorithms for increasing AI performance and capabilities. By reducing math operations to 8-bits or 4-bits, the TE allows for training larger networks faster without compromising accuracy. For example, the TEs may include a library for accelerating transformer models on processing devices—such as GPUs—to provide better performance with lower memory utilization in both training and inference. When the TE is combined with other technologies, such as high-speed interconnects between nodes (e.g., using NVLink Switch) and tensor cores (which enable mixed-precision computing, such as microscaling precision support), server clusters may be more capable of training enormous networks at high speeds. As such, tensor core precisions of FP64, TF32, BF16, FP16, FP8, INT8, FP6, and FP4 may be supported, as well as CUDA core precisions of FP64, FP32, FP16, and BF16.

### Inference and Training Logic

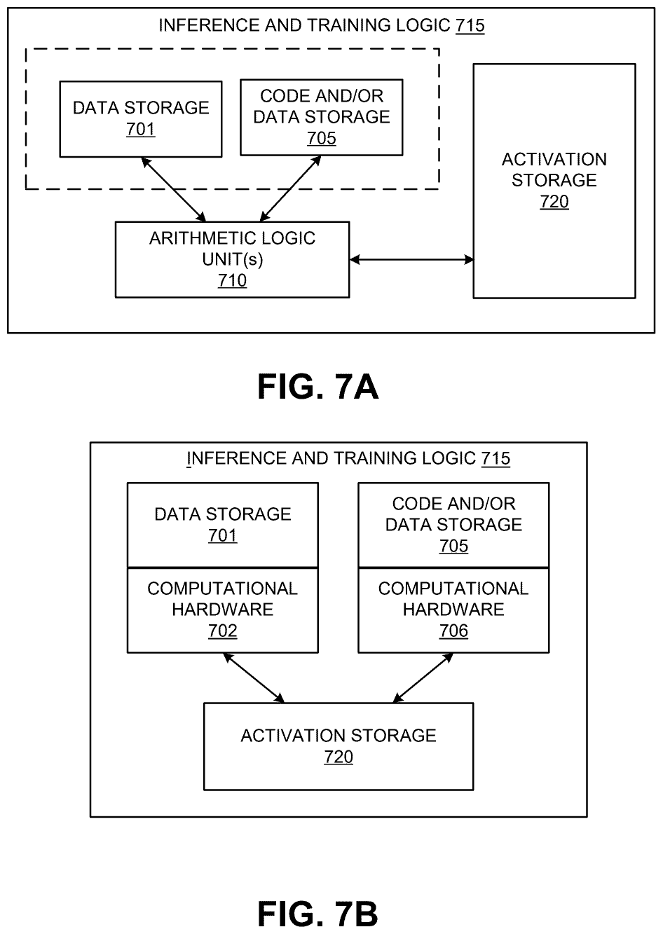

FIG. 7A illustrates inference and/or training logic 715 used to perform inferencing and/or training operations associated with one or more embodiments.

In at least one embodiment, inference and/or training logic 715 may include, without limitation, code and/or data storage 701 to store forward and/or output weight and/or input/output data, and/or other parameters to configure neurons or layers of a neural network trained and/or used for inferencing in aspects of one or more embodiments. In at least one embodiment, training logic 715 may include, or be coupled to code and/or data storage 701 to store graph code or other software to control timing and/or order, in which weight and/or other parameter information is to be loaded to configure, logic, including integer and/or floating-point units (collectively, arithmetic logic units (ALUs) or simply circuits). In at least one embodiment, code, such as graph code, loads weight or other parameter information into processor ALUs based on an architecture of a neural network to which such code corresponds. In at least one embodiment, code and/or data storage 701 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 701 may be included with other on-chip or off-chip data storage, including a processor's L1, L2, or L3 cache or system memory.

In at least one embodiment, any portion of code and/or data storage 701 may be internal or external to one or more processors or other hardware logic devices or circuits. In at least one embodiment, code and/or code and/or data storage 701 may be cache memory, dynamic randomly addressable memory (“DRAM”), static randomly addressable memory (“SRAM”), non-volatile memory (e.g., flash memory), or other storage. In at least one embodiment, a choice of whether code and/or code and/or data storage 701 is internal or external to a processor, for example, or comprising DRAM, SRAM, flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 may include, without limitation, a code and/or data storage 705 to store backward and/or output weight and/or input/output data corresponding to neurons or layers of a neural network trained and/or used for inferencing in aspects of one or more embodiments. In at least one embodiment, code and/or data storage 705 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 715 may include, or be coupled to code and/or data storage 705 to store graph code or other software to control timing and/or order, in which weight and/or other parameter information is to be loaded to configure, logic, including integer and/or floating point units (collectively, arithmetic logic units (ALUs).

In at least one embodiment, code, such as graph code, causes the loading of weight or other parameter information into processor ALUs based on an architecture of a neural network to which such code corresponds. In at least one embodiment, any portion of code and/or data storage 705 may be included with other on-chip or off-chip data storage, including a processor's L1, L2, or L3 cache or system memory. In at least one embodiment, any portion of code and/or data storage 705 may be internal or external to one or more processors or other hardware logic devices or circuits. In at least one embodiment, code and/or data storage 705 may be cache memory, DRAM, SRAM, non-volatile memory (e.g., flash memory), or other storage. In at least one embodiment, a choice of whether code and/or data storage 705 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 701 and code and/or data storage 705 may be separate storage structures. In at least one embodiment, code and/or data storage 701 and code and/or data storage 705 may be a combined storage structure. In at least one embodiment, code and/or data storage 701 and code and/or data storage 705 may be partially combined and partially separate. In at least one embodiment, any portion of code and/or data storage 701 and code and/or data storage 705 may be included with other on-chip or off-chip data storage, including a processor's L1, L2, or L3 cache or system memory.

In at least one embodiment, inference and/or training logic 715 may include, without limitation, one or more arithmetic logic unit(s) (“ALU(s)”) 710, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 720 that are functions of input/output and/or weight parameter data stored in code and/or data storage 701 and/or code and/or data storage 705. In at least one embodiment, activations stored in activation storage 720 are generated according to linear algebraic and or matrix-based mathematics performed by ALU(s) 710 in response to performing instructions or other code, wherein weight values stored in code and/or data storage 705 and/or data storage 701 are used as operands along with other values, such as bias values, gradient information, momentum values, or other parameters or hyperparameters, any or all of which may be stored in code and/or data storage 705 or code and/or data storage 701 or another storage on or off-chip.

In at least one embodiment, ALU(s) 710 are included within one or more processors or other hardware logic devices or circuits, whereas in another embodiment, ALU(s) 710 may be external to a processor or other hardware logic device or circuit that uses them (e.g., a co-processor). In at least one embodiment, ALU(s) 710 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 701, code and/or data storage 705, and activation storage 720 may share a processor or other hardware logic device or circuit, whereas in another embodiment, they may be in different processors or other hardware logic devices or circuits, or some combination of same and different processors or other hardware logic devices or circuits. In at least one embodiment, any portion of activation storage 720 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 720 may be cache memory, DRAM, SRAM, non-volatile memory (e.g., flash memory), or other storage. In at least one embodiment, activation storage 720 may be completely or partially within or external to one or more processors or other logical circuits. In at least one embodiment, a choice of whether activation storage 720 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 illustrated in FIG. 7A may be used in conjunction with an application-specific integrated circuit (“ASIC”), such as a TensorFlow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7A may be used in conjunction with central processing unit (“CPU”) hardware, graphics processing unit (“GPU”) hardware or other hardware, such as field programmable gate arrays (“FPGAs”).

FIG. 7B illustrates inference and/or training logic 715, according to at least one embodiment. In at least one embodiment, inference and/or training logic 715 may include, without limitation, hardware logic in which computational resources are dedicated or otherwise exclusively used in conjunction with weight values or other information corresponding to one or more layers of neurons within a neural network. In at least one embodiment, inference and/or training logic 715 illustrated in FIG. 7B may be used in conjunction with an application-specific integrated circuit (ASIC), such as TensorFlow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7B may be used in conjunction with central processing unit (CPU) hardware, graphics processing unit (GPU) hardware or other hardware, such as field programmable gate arrays (FPGAs). In at least one embodiment, inference and/or training logic 715 includes, without limitation, code and/or data storage 701 and code and/or data storage 705, which may be used to store code (e.g., graph code), weight values and/or other information, including bias values, gradient information, momentum values, and/or other parameter or hyperparameter information. In at least one embodiment illustrated in FIG. 7B, each of code and/or data storage 701 and code and/or data storage 705 is associated with a dedicated computational resource, such as computational hardware 702 and computational hardware 706, respectively. In at least one embodiment, each of computational hardware 702 and computational hardware 706 comprises one or more ALUs that perform mathematical functions, such as linear algebraic functions, only on information stored in code and/or data storage 701 and code and/or data storage 705, respectively, result of which is stored in activation storage 720.

In at least one embodiment, each of code and/or data storage 701 and 705 and corresponding computational hardware 702 and 706, respectively, correspond to different layers of a neural network, such that resulting activation from one storage/computational pair 701/702 of code and/or data storage 701 and computational hardware 702 is provided as an input to a next storage/computational pair 705/706 of code and/or data storage 705 and computational hardware 706, in order to mirror a conceptual organization of a neural network. In at least one embodiment, each of storage/computational pairs 701/702 and 705/706 may correspond to more than one neural network layer. In at least one embodiment, additional storage/computation pairs (not shown) subsequent to or in parallel with storage/computation pairs 701/702 and 705/706 may be included in inference and/or training logic 715.

### Neural Network Training and Deployment

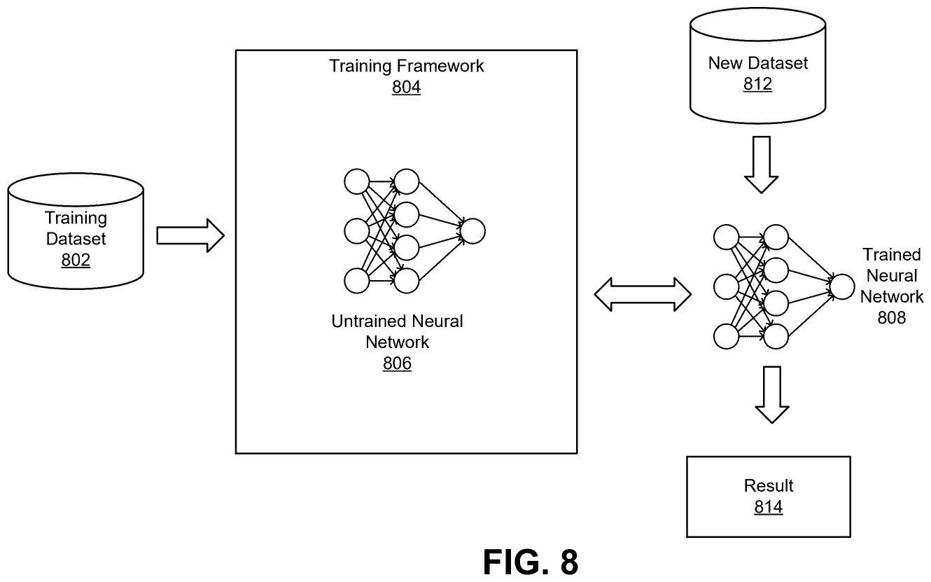

FIG. 8 illustrates training and deployment of a deep neural network, according to at least one embodiment. In at least one embodiment, untrained neural network 806 is trained using a training dataset 802. In at least one embodiment, training framework 804 is a PyTorch framework, whereas in other embodiments, training framework 804 is a TensorFlow, Boost, Caffe, Microsoft Cognitive Toolkit/CNTK, MXNet, Chainer, Keras, Deeplearning4j, or other training framework. In at least one embodiment, training framework 804 trains an untrained neural network 806 and enables it to be trained using processing resources described herein to generate a trained neural network 808. In at least one embodiment, weights may be chosen randomly or by pre-training using a deep belief network. In at least one embodiment, training may be performed in either a supervised, partially supervised, or unsupervised manner.

In at least one embodiment, untrained neural network 806 is trained using supervised learning, wherein training dataset 802 includes an input paired with a desired output for an input, or where training dataset 802 includes input having a known output and an output of neural network 806 is manually graded. In at least one embodiment, untrained neural network 806 is trained in a supervised manner and processes inputs from training dataset 802 and compares resulting outputs against a set of expected or desired outputs. In at least one embodiment, errors are then propagated back through untrained neural network 806. In at least one embodiment, training framework 804 adjusts weights that control untrained neural network 806. In at least one embodiment, training framework 804 includes tools to monitor how well untrained neural network 806 is converging towards a model, such as trained neural network 808, suitable to generating correct answers, such as in result 814, based on input data such as a new dataset 812. In at least one embodiment, training framework 804 trains untrained neural network 806 repeatedly while adjusting weights to refine an output of untrained neural network 806 using a loss function and adjustment algorithm, such as stochastic gradient descent. In at least one embodiment, training framework 804 trains untrained neural network 806 until untrained neural network 806 achieves a desired accuracy. In at least one embodiment, trained neural network 808 can then be deployed to implement any number of machine learning operations.

In at least one embodiment, untrained neural network 806 is trained using unsupervised learning, whereas untrained neural network 806 attempts to train itself using unlabeled data. In at least one embodiment, unsupervised learning training dataset 802 will include input data without any associated output data or “ground truth” data. In at least one embodiment, untrained neural network 806 can learn groupings within training dataset 802 and can determine how individual inputs are related to untrained dataset 802. In at least one embodiment, unsupervised training can be used to generate a self-organizing map in trained neural network 808 capable of performing operations useful in reducing dimensionality of new dataset 812. In at least one embodiment, unsupervised training can also be used to perform anomaly detection, which allows identification of data points in new dataset 812 that deviate from normal patterns of new dataset 812.

In at least one embodiment, semi-supervised learning may be used, which is a technique in which in training dataset 802 includes a mix of labeled and unlabeled data. In at least one embodiment, training framework 804 may be used to perform incremental learning, such as through transferred learning techniques. In at least one embodiment, incremental learning enables trained neural network 808 to adapt to new dataset 812 without forgetting knowledge instilled within trained neural network 808 during initial training.

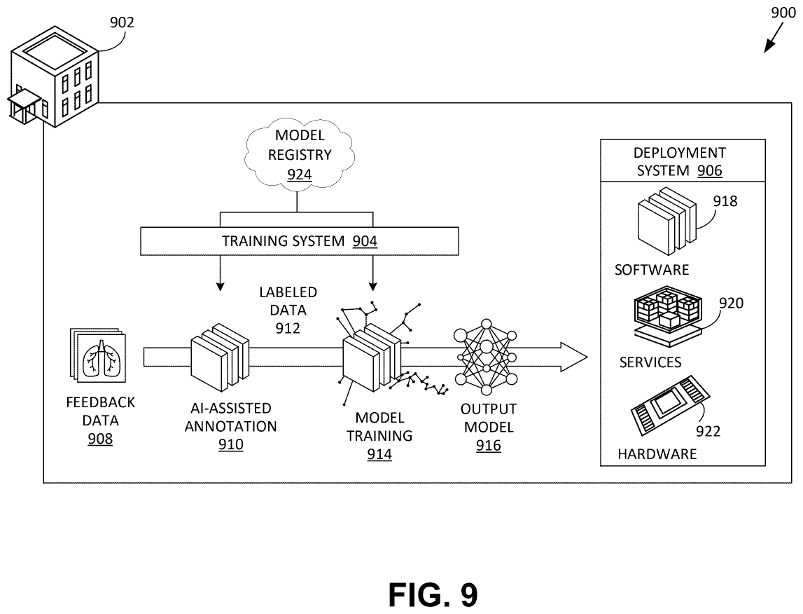

With reference to FIG. 9, FIG. 9 is an example data flow diagram for a process 900 of generating and deploying a processing and inferencing pipeline, according to at least one embodiment. In at least one embodiment, process 900 may be deployed to perform game name recognition analysis and inferencing on user feedback data at one or more facilities 902, such as a data center.

In at least one embodiment, process 900 may be executed within a training system 904 and/or a deployment system 906. In at least one embodiment, training system 904 may be used to perform training, deployment, and embodiment of machine learning models (e.g., neural networks, object detection algorithms, computer vision algorithms, etc.) for use in deployment system 906. In at least one embodiment, deployment system 906 may be configured to offload processing and compute resources among a distributed computing environment to reduce infrastructure requirements at facility 902. In at least one embodiment, deployment system 906 may provide a streamlined platform for selecting, customizing, and implementing virtual instruments for use with computing devices at facility 902. In at least one embodiment, virtual instruments may include software-defined applications for performing one or more processing operations with respect to feedback data. In at least one embodiment, one or more applications in a pipeline may use or call upon services (e.g., inference, visualization, compute, AI, etc.) of deployment system 906 during execution of applications.

In at least one embodiment, some applications used in advanced processing and inferencing pipelines may use machine learning models or other AI to perform one or more processing steps. In at least one embodiment, machine learning models may be trained at facility 902 using feedback data 908 (such as imaging data) stored at facility 902 or feedback data 908 from another facility or facilities, or a combination thereof. In at least one embodiment, training system 904 may be used to provide applications, services, and/or other resources for generating working, deployable machine learning models for deployment system 906.

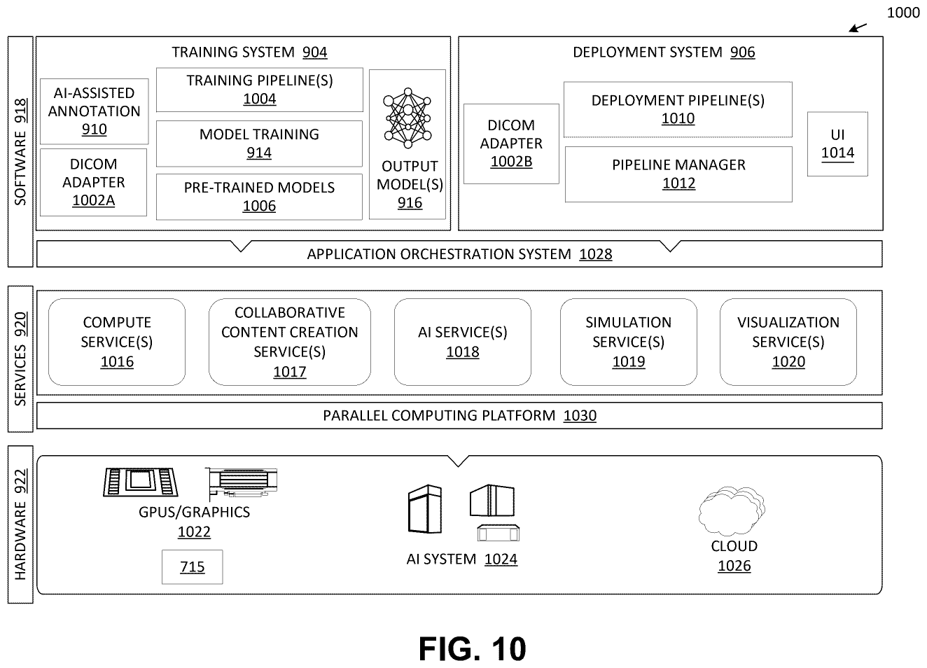

In at least one embodiment, a model registry 924 may be backed by object storage that may support versioning and object metadata. In at least one embodiment, object storage may be accessible through, for example, a cloud storage (e.g., a cloud 1026 of FIG. 10) compatible application programming interface (API) from within a cloud platform. In at least one embodiment, machine learning models within model registry 924 may be uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, a training pipeline 1004 (FIG. 10) may include a scenario where facility 902 is training their own machine learning model, or has an existing machine learning model that needs to be optimized or updated. In at least one embodiment, feedback data 908 may be received from various channels, such as forums, web forms, or the like. In at least one embodiment, once feedback data 908 is received, AI-assisted annotation 910 may be used to aid in generating annotations corresponding to feedback data 908 to be used as ground truth data for a machine learning model. In at least one embodiment, AI-assisted annotation 910 may include one or more machine learning models (e.g., convolutional neural networks (CNNs)) that may be trained to generate annotations corresponding to certain types of feedback data 908 (e.g., from certain devices) and/or certain types of anomalies in feedback data 908. In at least one embodiment, AI-assisted annotations 910 may then be used directly, or may be adjusted or fine-tuned using an annotation tool, to generate ground truth data. In at least one embodiment, in some examples, labeled data 912 may be used as ground truth data for training a machine learning model. In at least one embodiment, AI-assisted annotations 910, labeled data 912, or a combination thereof may be used as ground truth data for training a machine learning model, e.g., via model training 914 in FIGS. 9-10. In at least one embodiment, a trained machine learning model may be referred to as an output model 916, and may be used by deployment system 906, as described herein.

In at least one embodiment, training pipeline 1004 (FIG. 10) may include a scenario where facility 902 needs a machine learning model for use in performing one or more processing tasks for one or more applications in deployment system 906, but facility 902 may not currently have such a machine learning model (or may not have a model that is optimized, efficient, or effective for such purposes). In at least one embodiment, an existing machine learning model may be selected from model registry 924. In at least one embodiment, model registry 924 may include machine learning models trained to perform a variety of different inference tasks on imaging data. In at least one embodiment, machine learning models in model registry 924 may have been trained on imaging data from different facilities than facility 902 (e.g., facilities that are remotely located). In at least one embodiment, machine learning models may have been trained on imaging data from one location, two locations, or any number of locations. In at least one embodiment, when being trained on imaging data, which may be a form of feedback data 908, from a specific location, training may take place at that location, or at least in a manner that protects confidentiality of imaging data or restricts imaging data from being transferred off-premises (e.g., to comply with HIPAA regulations, privacy regulations, etc.). In at least one embodiment, once a model is trained—or partially trained—at one location, a machine learning model may be added to model registry 924. In at least one embodiment, a machine learning model may then be retrained, or updated, at any number of other facilities, and a retrained or updated model may be made available in model registry 924. In at least one embodiment, a machine learning model may then be selected from model registry 924—and referred to as output model 916—and may be used in deployment system 906 to perform one or more processing tasks for one or more applications of a deployment system.

In at least one embodiment, training pipeline 1004 (FIG. 10) may be used in a scenario that includes facility 902 requiring a machine learning model for use in performing one or more processing tasks for one or more applications in deployment system 906, but facility 902 may not currently have such a machine learning model (or may not have a model that is optimized, efficient, or effective for such purposes). In at least one embodiment, a machine learning model selected from model registry 924 might not be fine-tuned or optimized for feedback data 908 generated at facility 902 because of differences in populations, genetic variations, robustness of training data used to train a machine learning model, diversity in anomalies of training data, and/or other issues with training data. In at least one embodiment, AI-assisted annotation 910 may be used to aid in generating annotations corresponding to feedback data 908 to be used as ground truth data for retraining or updating a machine learning model. In at least one embodiment, labeled data 912 may be used as ground truth data for training a machine learning model. In at least one embodiment, retraining or updating a machine learning model may be referred to as model training 914. In at least one embodiment, model training 914—e.g., AI-assisted annotations 910, labeled data 912, or a combination thereof—may be used as ground truth data for retraining or updating a machine learning model.

In at least one embodiment, deployment system 906 may include software 918, services 920, hardware 922, and/or other components, features, and functionality. In at least one embodiment, deployment system 906 may include a software “stack,” such that software 918 may be built on top of services 920 and may use services 920 to perform some or all of processing tasks, and services 920 and software 918 may be built on top of hardware 922 and use hardware 922 to execute processing, storage, and/or other compute tasks of deployment system 906.

In at least one embodiment, software 918 may include any number of different containers, where each container may execute an instantiation of an application. In at least one embodiment, each application may perform one or more processing tasks in an advanced processing and inferencing pipeline (e.g., inferencing, object detection, feature detection, segmentation, image enhancement, calibration, etc.). In at least one embodiment, for each type of computing device there may be any number of containers that may perform a data processing task with respect to feedback data 908 (or other data types, such as those described herein). In at least one embodiment, an advanced processing and inferencing pipeline may be defined based on selections of different containers that are desired or required for processing feedback data 908, in addition to containers that receive and configure imaging data for use by each container and/or for use by facility 902 after processing through a pipeline (e.g., to convert outputs back to a usable data type for storage and display at facility 902). In at least one embodiment, a combination of containers within software 918 (e.g., that make up a pipeline) may be referred to as a virtual instrument (as described in more detail herein), and a virtual instrument may leverage services 920 and hardware 922 to execute some or all processing tasks of applications instantiated in containers.

In at least one embodiment, data may undergo pre-processing as part of data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (e.g., as a response to an inference request). In at least one embodiment, inferencing tasks may be performed by one or more machine learning models, such as trained or deployed neural networks, which may include output models 916 of training system 904.

In at least one embodiment, tasks of data processing pipeline may be encapsulated in one or more container(s) that each represent a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 924 and associated with one or more applications. In at least one embodiment, images of applications (e.g., container images) may be available in a container registry, and once selected by a user from a container registry for deployment in a pipeline, an image may be used to generate a container for an instantiation of an application for use by a user system.

In at least one embodiment, developers may develop, publish, and store applications (e.g., as containers) for performing processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 920 as a system (e.g., architecture 1000 of FIG. 10). In at least one embodiment, once validated by architecture 1000 (e.g., for accuracy, etc.), an application may be available in a container registry for selection and/or embodiment by a user (e.g., a hospital, clinic, lab, healthcare provider, etc.) to perform one or more processing tasks with respect to data at a facility (e.g., a second facility) of a user.

In at least one embodiment, developers may then share applications or containers through a network for access and use by users of a system (e.g., architecture 1000 of FIG. 10). In at least one embodiment, completed and validated applications or containers may be stored in a container registry and associated machine learning models may be stored in model registry 924. In at least one embodiment, a requesting entity that provides an inference or image processing request may browse a container registry and/or model registry 924 for an application, container, dataset, machine learning model, etc., select a desired combination of elements for inclusion in data processing pipeline, and submit a processing request. In at least one embodiment, a request may include input data that is necessary to perform a request, and/or may include a selection of application(s) and/or machine learning models to be executed in processing a request. In at least one embodiment, a request may then be passed to one or more components of deployment system 906 (e.g., a cloud) to perform processing of a data processing pipeline. In at least one embodiment, processing by deployment system 906 may include referencing selected elements (e.g., applications, containers, models, etc.) from a container registry and/or model registry 924. In at least one embodiment, once results are generated by a pipeline, results may be returned to a user for reference (e.g., for viewing in a viewing application suite executing on a local, on-premises workstation or terminal).

In at least one embodiment, to aid in processing or execution of applications or containers in pipelines, services 920 may be leveraged. In at least one embodiment, services 920 may include compute services, collaborative content creation services, simulation services, artificial intelligence (AI) services, visualization services, and/or other service types. In at least one embodiment, services 920 may provide functionality that is common to one or more applications in software 918, so functionality may be abstracted to a service that may be called upon or leveraged by applications. In at least one embodiment, functionality provided by services 920 may run dynamically and more efficiently, while also scaling well by allowing applications to process data in parallel, e.g., using a parallel computing platform 1030 (FIG. 10). In at least one embodiment, rather than each application that shares a same functionality offered by a service 920 being required to have a respective instance of service 920, service 920 may be shared between and among various applications. In at least one embodiment, services may include an inference server or engine that may be used for executing detection or segmentation tasks, as non-limiting examples. In at least one embodiment, a model training service may be included that may provide machine learning model training and/or retraining capabilities.

In at least one embodiment, where a service 920 includes an AI service (e.g., an inference service), one or more machine learning models associated with an application for anomaly detection (e.g., tumors, growth abnormalities, scarring, etc.) may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more of processing operations associated with segmentation tasks. In at least one embodiment, software 918 implementing advanced processing and inferencing pipeline may be streamlined because each application may call upon the same inference service to perform one or more inferencing tasks.

In at least one embodiment, hardware 922 may include GPUs, CPUs, graphics cards, an AI/deep learning system (e.g., an AI supercomputer, such as NVIDIA's DGX™ supercomputer system), a cloud platform, or a combination thereof. In at least one embodiment, different types of hardware 922 may be used to provide efficient, purpose-built support for software 918 and services 920 in deployment system 906. In at least one embodiment, use of GPU processing may be implemented for processing locally (e.g., at facility 902), within an AI/deep learning system, in a cloud system, and/or in other processing components of deployment system 906 to improve efficiency, accuracy, and efficacy of game name recognition.

In at least one embodiment, software 918 and/or services 920 may be optimized for GPU processing with respect to deep learning, machine learning, and/or high-performance computing, simulation, and visual computing, as non-limiting examples. In at least one embodiment, at least some of the computing environment of deployment system 906 and/or training system 904 may be executed in a datacenter or one or more supercomputers or high performance computing systems, with GPU-optimized software (e.g., hardware and software combination of NVIDIA's DGX™ system). In at least one embodiment, hardware 922 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform (e.g., NVIDIA's NGC™) may be executed using an AI/deep learning supercomputer(s) and/or GPU-optimized software (e.g., as provided on NVIDIA's DGX™ systems) as a hardware abstraction and scaling platform. In at least one embodiment, cloud platform may integrate an application container clustering system or orchestration system (e.g., KUBERNETES) on multiple GPUs to enable seamless scaling and load balancing.

FIG. 10 is a system diagram for an example architecture 1000 for generating and deploying a deployment pipeline, according to at least one embodiment. In at least one embodiment, architecture 1000 may be used to implement process 900 of FIG. 9 and/or other processes including advanced processing and inferencing pipelines. In at least one embodiment, architecture 1000 may include training system 904 and deployment system 906. In at least one embodiment, training system 904 and deployment system 906 may be implemented using software 918, services 920, and/or hardware 922, as described herein.

In at least one embodiment, architecture 1000 (e.g., training system 904 and/or deployment system 906) may implemented in a cloud computing environment (e.g., using cloud 1026). In at least one embodiment, architecture 1000 may be implemented locally with respect to a facility, or as a combination of both cloud and local computing resources. In at least one embodiment, access to APIs in cloud 1026 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of architecture 1000, may be restricted to a set of public internet service providers (ISPs) that have been vetted or authorized for interaction.

In at least one embodiment, various components of architecture 1000 may communicate between and among one another using any of a variety of different network types, including but not limited to local area networks (LANs) and/or wide area networks (WANs) via wired and/or wireless communication protocols. In at least one embodiment, communication between facilities and components of architecture 1000 (e.g., for transmitting inference requests, for receiving results of inference requests, etc.) may be communicated over a data bus or data busses, wireless data protocols (Wi-Fi), wired data protocols (e.g., Ethernet), etc.

In at least one embodiment, training system 904 may execute training pipelines 1004, similar to those described herein with respect to FIG. 9. In at least one embodiment, where one or more machine learning models are to be used in deployment pipelines 1010 by deployment system 906, training pipelines 1004 may be used to train or retrain one or more (e.g., pre-trained) models, and/or implement one or more of pre-trained models 1006 (e.g., without a need for retraining or updating). In at least one embodiment, as a result of training pipelines 1004, output model(s) 916 may be generated. In at least one embodiment, training pipelines 1004 may include any number of processing steps, AI-assisted annotation 910, labeling or annotating of feedback data 908 to generate labeled data 912, model selection from a model registry, model training 914, training, retraining, or updating models, and/or other processing steps. In at least one embodiment, for different machine learning models used by deployment system 906, different training pipelines 1004 may be used. In at least one embodiment, training pipeline 1004, similar to a first example described with respect to FIG. 9, may be used for a first machine learning model, training pipeline 1004, similar to a second example described with respect to FIG. 9, may be used for a second machine learning model, and training pipeline 1004, similar to a third example described with respect to FIG. 9, may be used for a third machine learning model. In at least one embodiment, any combination of tasks within training system 904 may be used depending on what is required for each respective machine learning model. In at least one embodiment, one or more of machine learning models may already be trained and ready for deployment so machine learning models may not undergo any processing by training system 904, and may be implemented by deployment system 906.

In at least one embodiment, output model(s) 916 and/or pre-trained model(s) 1006 may include any types of machine learning models depending on embodiment. In at least one embodiment, and without limitation, machine learning models used by architecture 1000 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Bi-LSTM, Hopfield, Boltzmann, deep belief, deconvolutional, generative adversarial, liquid state machine, etc.), and/or other types of machine learning models.

In at least one embodiment, training pipelines 1004 may include AI-assisted annotation. In at least one embodiment, labeled data 912 (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of feedback data 908 (or other data type used by machine learning models), there may be corresponding ground truth data generated by training system 904. In at least one embodiment, AI-assisted annotation may be performed as part of deployment pipelines 1010; either in addition to, or in lieu of, AI-assisted annotation included in training pipelines 1004. In at least one embodiment, architecture 1000 may include a multi-layer platform that may include a software layer (e.g., software 918) of diagnostic applications (or other application types) that may perform one or more medical imaging and diagnostic functions.

In at least one embodiment, a software layer may be implemented as a secure, encrypted, and/or authenticated API through which applications or containers may be invoked (e.g., called) from an external environment(s), e.g., facility 902. In at least one embodiment, applications may then call or execute one or more services 920 for performing compute, AI, or visualization tasks associated with respective applications, and software 918 and/or services 920 may leverage hardware 922 to perform processing tasks in an effective and efficient manner.

In at least one embodiment, deployment system 906 may execute deployment pipelines 1010. In at least one embodiment, deployment pipelines 1010 may include any number of applications that may be sequentially, non-sequentially, or otherwise applied to feedback data (and/or other data types), including AI-assisted annotation, as described above. In at least one embodiment, as described herein, a deployment pipeline 1010 for an individual device may be referred to as a virtual instrument for a device. In at least one embodiment, for a single device, there may be more than one deployment pipeline 1010 depending on information desired from data generated by a device.

In at least one embodiment, applications available for deployment pipelines 1010 may include any application that may be used for performing processing tasks on feedback data or other data from devices. In at least one embodiment, because various applications may share common image operations, in some embodiments, a data augmentation library (e.g., as one of services 920) may be used to accelerate these operations. In at least one embodiment, to avoid bottlenecks of conventional processing approaches that rely on CPU processing, parallel computing platform 1030 may be used for GPU acceleration of these processing tasks.

In at least one embodiment, deployment system 906 may include a user interface (UI) 1014 (e.g., a graphical user interface, a web interface, etc.) that may be used to select applications for inclusion in deployment pipeline(s) 1010, arrange applications, modify or change applications or parameters or constructs thereof, use and intera with deployment pipeline(s) 1010 during set-up and/or deployment, and/or to otherwise interact with deployment system 906. In at least one embodiment, although not illustrated with respect to training system 904, UI 1014 (or a different user interface) may be used for selecting models for use in deployment system 906, for selecting models for training, or retraining, in training system 904, and/or for otherwise interacting with training system 904. In at least one embodiment, training system 904 and deployment system 906 may include DICOM adapters 1002A and 1002B.

In at least one embodiment, pipeline manager 1012 may be used, in addition to an application orchestration system 1028, to manage interaction between applications or containers of deployment pipeline(s) 1010 and services 920 and/or hardware 922. In at least one embodiment, pipeline manager 1012 may be configured to facilitate interactions from application to application, from application to service 920, and/or from application or service to hardware 922. In at least one embodiment, although illustrated as included in software 918, this is not intended to be limiting, and in some examples pipeline manager 1012 may be included in services 920. In at least one embodiment, application orchestration system 1028 (e.g., Kubernetes, DOCKER, etc.) may include a container orchestration system that may group applications into containers as logical units for coordination, management, scaling, and deployment. In at least one embodiment, by associating applications from deployment pipeline(s) 1010 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of other application(s) or container(s). In at least one embodiment, communication, and cooperation between different containers or applications may be aided by pipeline manager 1012 and application orchestration system 1028. In at least one embodiment, so long as an expected input and/or output of each container or application is known by a system (e.g., based on constructs of applications or containers), application orchestration system 1028 and/or pipeline manager 1012 may facilitate communication among and between, and sharing of resources among and between, each of applications or containers. In at least one embodiment, because one or more of applications or containers in deployment pipeline(s) 1010 may share the same services and resources, application orchestration system 1028 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, the scheduler may thus allocate resources to different applications and distribute resources between and among applications in view of requirements and availability of a system. In some examples, the scheduler (and/or other component of application orchestration system 1028) may determine resource availability and distribution based on constraints imposed on a system (e.g., user constraints), such as quality of service (QoS), urgency of need for data outputs (e.g., to determine whether to execute real-time processing or delayed processing), etc.

In at least one embodiment, services 920 leveraged and shared by applications or containers in deployment system 906 may include compute services 1016, collaborative content creation services 1017, AI services 1018, simulation services 1019, visualization services 1020, and/or other service types. In at least one embodiment, applications may call (e.g., execute) one or more of services 920 to perform processing operations for an application. In at least one embodiment, compute services 1016 may be leveraged by applications to perform super-computing or other high-performance computing (HPC) tasks. In at least one embodiment, compute service(s) 1016 may be leveraged to perform parallel processing (e.g., using a parallel computing platform 1030) for processing data through one or more of applications and/or one or more tasks of a single application, substantially simultaneously. In at least one embodiment, parallel computing platform 1030 (e.g., NVIDIA's CUDA®) may enable general purpose computing on GPUs (GPGPU) (e.g., GPUs 1022). In at least one embodiment, a software layer of parallel computing platform 1030 may provide access to virtual instruction sets and parallel computational elements of GPUs, for execution of compute kernels. In at least one embodiment, parallel computing platform 1030 may include memory and, in some embodiments, a memory may be shared between and among multiple containers, and/or between and among different processing tasks within a single container. In at least one embodiment, inter-process communication (IPC) calls may be generated for multiple containers and/or for multiple processes within a container to use same data from a shared segment of memory of parallel computing platform 1030 (e.g., where multiple different stages of an application or multiple applications are processing same information). In at least one embodiment, rather than making a copy of data and moving data to different locations in memory (e.g., a read/write operation), same data in the same location of a memory may be used for any number of processing tasks (e.g., at the same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI services 1018 may be leveraged to perform inferencing services for executing machine learning model(s) associated with applications (e.g., tasked with performing one or more processing tasks of an application). In at least one embodiment, AI services 1018 may leverage AI system 1024 to execute machine learning model(s) (e.g., neural networks, such as CNNs) for segmentation, reconstruction, object detection, feature detection, classification, and/or other inferencing tasks. In at least one embodiment, applications of deployment pipeline(s) 1010 may use one or more of output models 916 from training system 904 and/or other models of applications to perform inference on imaging data (e.g., DICOM data, RIS data, CIS data, REST compliant data, RPC data, raw data, etc.). In at least one embodiment, two or more examples of inferencing using application orchestration system 1028 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 1028 may distribute resources (e.g., services 920 and/or hardware 922) based on priority paths for different inferencing tasks of AI services 1018.

In at least one embodiment, shared storage may be mounted to AI services 1018 within architecture 1000. In at least one embodiment, shared storage may operate as a cache (or other storage device type) and may be used to process inference requests from applications. In at least one embodiment, when an inference request is submitted, a request may be received by a set of API instances of deployment system 906, and one or more instances may be selected (e.g., for best fit, for load balancing, etc.) to process a request. In at least one embodiment, to process a request, a request may be entered into a database, a machine learning model may be located from model registry 924 if not already in a cache, a validation step may ensure appropriate machine learning model is loaded into a cache (e.g., shared storage), and/or a copy of a model may be saved to a cache. In at least one embodiment, the scheduler (e.g., of pipeline manager 1012) may be used to launch an application that is referenced in a request if an application is not already running or if there are not enough instances of an application. In at least one embodiment, if an inference server is not already launched to execute a model, an inference server may be launched. In at least one embodiment, any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as the inference server is running as a different instance.

In at least one embodiment, during application execution, an inference request for a given application may be received, and a container (e.g., hosting an instance of an inference server) may be loaded (if not already loaded), and a start procedure may be called. In at least one embodiment, pre-processing logic in a container may load, decode, and/or perform any additional pre-processing on incoming data (e.g., using a CPU(s) and/or GPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel level-segmentation, voxel-level segmentation, generating a visualization, or generating text to summarize findings. In at least one embodiment, different models or applications may be assigned different priorities. For example, some models may have a real-time (turnaround time less than one minute) priority while others may have lower priority (e.g., turnaround less than 10 minutes). In at least one embodiment, model execution times may be measured from requesting institution or entity and may include partner network traversal time, as well as execution on an inference service.

In at least one embodiment, transfer of requests between services 920 and inference applications may be hidden behind a software development kit (SDK), and robust transport may be provided through a queue. In at least one embodiment, a request is placed in a queue via an API for an individual application/tenant ID combination and an SDK pulls a request from a queue and gives a request to an application. In at least one embodiment, a name of a queue may be provided in an environment from where an SDK picks up the request. In at least one embodiment, asynchronous communication through a queue may be useful as it may allow any instance of an application to pick up work as it becomes available. In at least one embodiment, results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 1026, and an inference service may perform inferencing on a GPU.

In at least one embodiment, visualization services 1020 may be leveraged to generate visualizations for viewing outputs of applications and/or deployment pipeline(s) 1010. In at least one embodiment, GPUs 1022 may be leveraged by visualization services 1020 to generate visualizations. In at least one embodiment, rendering effects, such as ray-tracing or other light transport simulation techniques, may be implemented by visualization services 1020 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization services 1020 may include an internal visualizer, cinematics, and/or other rendering or image processing capabilities or functionality (e.g., ray tracing, rasterization, internal optics, etc.).

In at least one embodiment, hardware 922 may include GPUs 1022, AI system 1024, cloud 1026, and/or any other hardware used for executing training system 904 and/or deployment system 906. In at least one embodiment, GPUs 1022 (e.g., NVIDIA's TESLA® and/or QUADRO® GPUs) may include any number of GPUs that may be used for executing processing tasks of compute services 1016, collaborative content creation services 1017, AI services 1018, simulation services 1019, visualization services 1020, other services, and/or any of features or functionality of software 918. For example, with respect to AI services 1018, GPUs 1022 may be used to perform pre-processing on imaging data (or other data types used by machine learning models), post-processing on outputs of machine learning models, and/or to perform inferencing (e.g., to execute machine learning models). In at least one embodiment, cloud 1026, AI system 1024, and/or other components of architecture 1000 may use GPUs 1022. In at least one embodiment, cloud 1026 may include a GPU-optimized platform for deep learning tasks. In at least one embodiment, AI system 1024 may use GPUs, and cloud 1026—or at least a portion tasked with deep learning or inferencing—may be executed using one or more AI systems 1024. As such, although hardware 922 is illustrated as discrete components, this is not intended to be limiting, and any components of hardware 922 may be combined with, or leveraged by, any other components of hardware 922.

In at least one embodiment, AI system 1024 may include a purpose-built computing system (e.g., a super-computer or an HPC) configured for inferencing, deep learning, machine learning, and/or other artificial intelligence tasks. In at least one embodiment, AI system 1024 (e.g., NVIDIA's DGX™) may include GPU-optimized software (e.g., a software stack) that may be executed using a plurality of GPUs 1022, in addition to CPUs, RAM, storage, and/or other components, features, or functionality. In at least one embodiment, one or more AI systems 1024 may be implemented in cloud 1026 (e.g., in a data center) for performing some or all of AI-based processing tasks of architecture 1000.

In at least one embodiment, cloud 1026 may include a GPU-accelerated infrastructure (e.g., NVIDIA's NGC™) that may provide a GPU-optimized platform for executing processing tasks of architecture 1000. In at least one embodiment, cloud 1026 may include an AI system(s) 1024 for performing one or more of AI-based tasks of architecture 1000 (e.g., as a hardware abstraction and scaling platform). In at least one embodiment, cloud 1026 may integrate with application orchestration system 1028 leveraging multiple GPUs to enable seamless scaling and load balancing between and among applications and services 920. In at least one embodiment, cloud 1026 may be tasked with executing at least some of services 920 of architecture 1000, including compute services 1016, AI services 1018, and/or visualization services 1020, as described herein. In at least one embodiment, cloud 1026 may perform small and large batch inference (e.g., executing NVIDIA's TensorRT™), provide an accelerated parallel computing API and platform 1030 (e.g., NVIDIA's CUDA®), execute application orchestration system 1028 (e.g., KUBERNETES), provide a graphics rendering API and platform (e.g., for ray-tracing, 2D graphics, 3D graphics, and/or other rendering techniques to produce higher quality cinematics), and/or may provide other functionality for architecture 1000.

In at least one embodiment, in an effort to preserve patient confidentiality (e.g., where patient data or records are to be used off-premises), cloud 1026 may include a registry, such as a deep learning container registry. In at least one embodiment, a registry may store containers for instantiations of applications that may perform pre-processing, post-processing, or other processing tasks on patient data. In at least one embodiment, cloud 1026 may receive data that includes patient data as well as sensor data in containers, perform requested processing for just sensor data in those containers, and then forward a resultant output and/or visualizations to appropriate parties and/or devices (e.g., on-premises medical devices used for visualization or diagnoses), all without having to extract, store, or otherwise access patient data. In at least one embodiment, confidentiality of patient data is preserved in compliance with HIPAA and/or other data regulations.

### Example Language Models

In at least some embodiments, language models, such as large language models (LLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/VLMs/MMLMs/etc. architectures may be implemented in various embodiments. For example, different architectures may be implemented that use different techniques for understanding and generating outputs—such as text, audio, video, image, 2D and/or 3D design or asset data, etc. In some embodiments, LLMs/VLMs/MMLMs/etc. architectures such as recurrent neural networks (RNNs) or long short-term memory networks (LSTMs) may be used, while in other embodiments transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/VLMs/MMLMs/etc. may also include one or more diffusion block(s) (e.g., denoisers). The LLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/VLMs/MMLMs/etc. that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular embodiment and the task(s) being performed using the LLMs/VLMs/MMLMs/etc.

In various embodiments, the LLMs/VLMs/MMLMs/etc. may be trained using unsupervised learning, in which an LLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/embodiment. As a result, the LLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/embodiment.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

In some embodiments, multiple language models (e.g., LLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

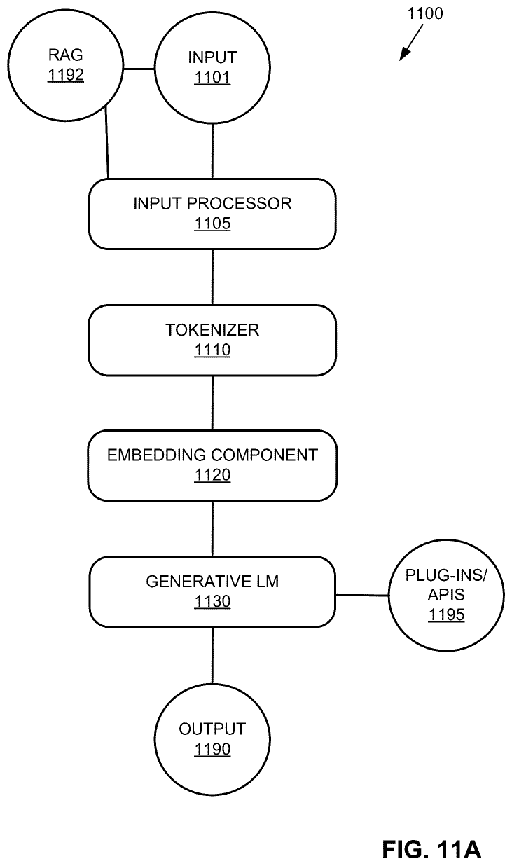

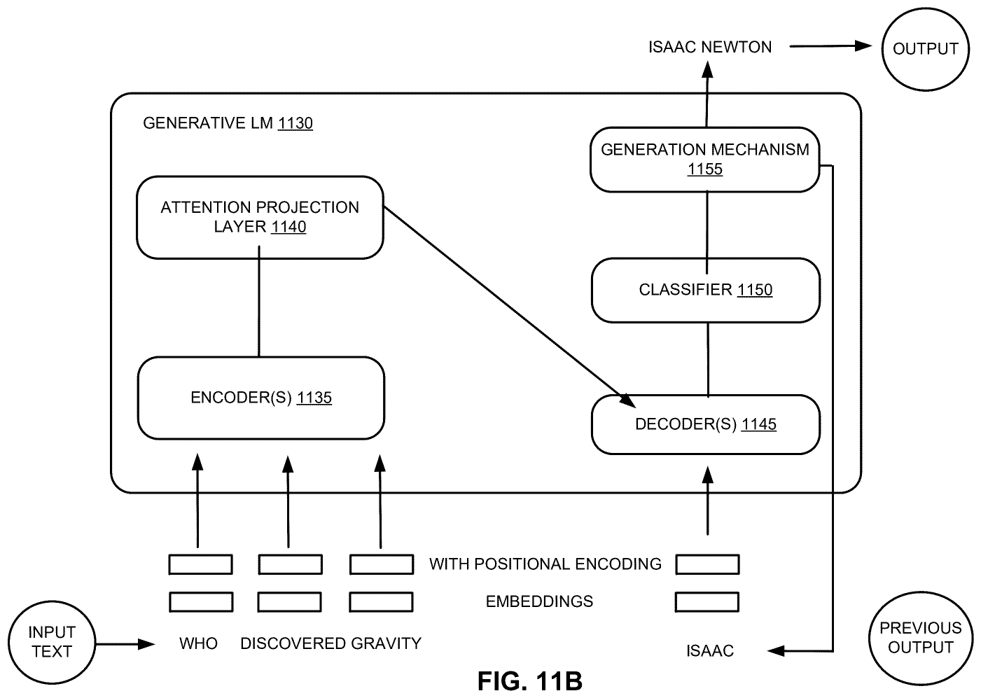

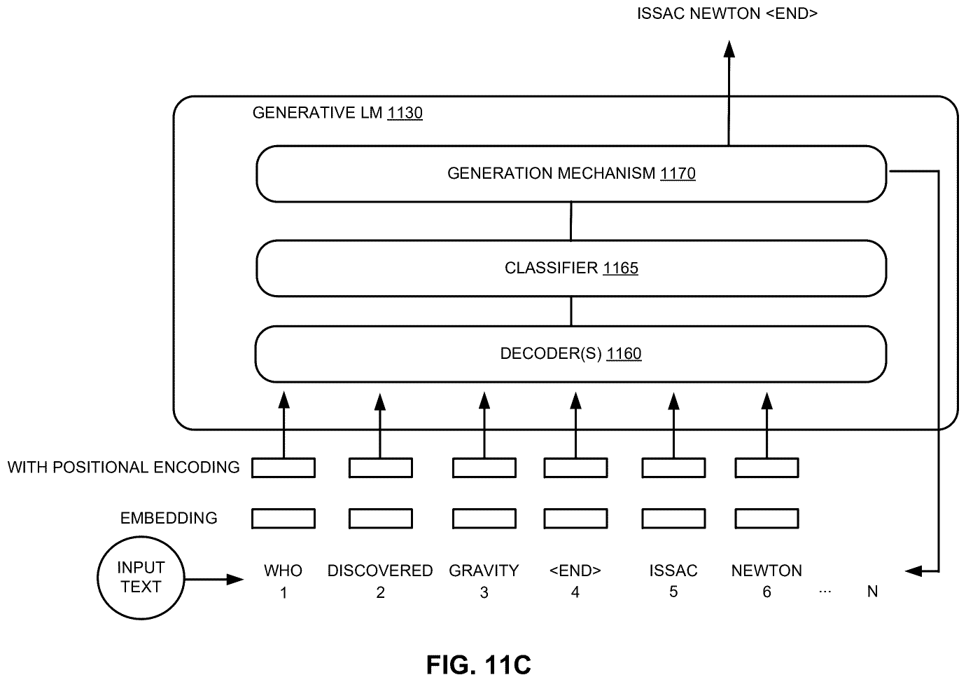

FIG. 11A is a block diagram of an example generative language model system 1100 suitable for use in implementing at least some embodiments of the present disclosure. In the example illustrated in FIG. 11A, the generative language model system 1100 includes a retrieval augmented generation (RAG) component 1192, an input processor 1105, a tokenizer 1110, an embedding component 1120, plug-ins/APIs 1195, and a generative language model (LM) 1130 (which may include an LLM, a VLM, a multi-modal LM, etc.).

At a high level, the input processor 1105 may receive an input 1101 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 1130 (e.g., LLM/VLM/MMLM/etc.). In some embodiments, the input 1101 includes plain text in the form of one or more sentences, paragraphs, and/or documents. Additionally or alternatively, the input 1101 may include numerical sequences, precomputed embeddings (e.g., word or sentence embeddings), and/or structured data (e.g., in tabular formats, JSON, or XML). In some embodiments in which the generative LM 1130 is capable of processing multi-modal inputs, the input 1101 may combine text (or may omit text) with image data, audio data, video data, design data, USD data, and/or other types of input data, such as but not limited to those described herein. Taking raw input text as an example, the input processor 1105 may prepare raw input text in various ways. For example, the input processor 1105 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 1105 may remove stopwords to reduce noise and focus the generative LM 1130 on more meaningful content. The input processor 1105 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 1192 (which may include one or more RAG models, and/or may be performed using the generative LM 1130 itself) may be used to retrieve additional information to be used as part of the input 1101 or prompt. RAG may be used to enhance the input to the LLM/VLM/MMLM/etc. with external knowledge, so that answers to specific questions or queries or requests are more relevant—such as in a case where specific knowledge is required. The RAG component 1192 may fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some embodiments, the input 1101 may be generated using the query or input to the model (e.g., a question, a request, etc.) in addition to data retrieved using the RAG component 1192. In some embodiments, the input processor 1105 may analyze the input 1101 and communicate with the RAG component 1192 (or the RAG component 1192 may be part of the input processor 1105, in embodiments) in order to identify relevant text and/or other data to provide to the generative LM 1130 as additional context or sources of information from which to identify the response, answer, or output 1190, generally. For example, where the input indicates that the user is interested in a desired tire pressure for a particular make and model of vehicle, the RAG component 1192 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 1192 may retrieve a prior stored conversation history—or at least a summary thereof—and include the prior conversation history along with the current ask/request as part of the input 1101 to the generative LM 1130.

The RAG component 1192 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 1192 and the embeddings of the chunks along with the embeddings of the query may be compared to identify the most similar/related embeddings to the query, which may be supplied to the generative LM 1130 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 1192 may implement a plugin, API, user interface, and/or other functionality to perform RAG. For example, a graph RAG plug-in may be used by the LLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 1110 may segment the (e.g., processed) text data into smaller units (tokens) for subsequent analysis and processing. The tokens may represent individual words, subwords, characters, portions of audio/video/image/etc., depending on the embodiment. Word-based tokenization divides the text into individual words, treating each word as a separate token. Subword tokenization breaks down words into smaller meaningful units (e.g., prefixes, suffixes, stems), enabling the generative LM 1130 to understand morphological variations and handle out-of-vocabulary words more effectively. Character-based tokenization represents each character as a separate token, enabling the generative LM 1130 to process text at a fine-grained level. The choice of tokenization strategy may depend on factors such as the language being processed, the task at hand, and/or characteristics of the training dataset. As such, the tokenizer 1110 may convert the (e.g., processed) text into a structured format according to tokenization schema being implemented in the particular embodiment.

The embedding component 1120 may use any known embedding technique to transform discrete tokens into (e.g., dense, continuous vector) representations of semantic meaning. For example, the embedding component 1120 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some embodiments in which the input 1101 includes image data/video data/etc., the input processor 1101 may resize the data to a standard size compatible with format of a corresponding input channel and/or may normalize pixel values to a common range (e.g., 0 to 1) to ensure a consistent representation, and the embedding component 1120 may encode the image data using any known technique (e.g., using one or more convolutional neural networks (CNNs) to extract visual features). In some embodiments in which the input 1101 includes audio data, the input processor 1101 may resample an audio file to a consistent sampling rate for uniform processing, and the embedding component 1120 may use any known technique to extract and encode audio features—such as in the form of a spectrogram (e.g., a mel-spectrogram). In some embodiments in which the input 1101 includes video data, the input processor 1101 may extract frames or apply resizing to extracted frames, and the embedding component 1120 may extract features such as optical flow embeddings or video embeddings and/or may encode temporal information or sequences of frames. In some embodiments in which the input 1101 includes multi-modal data, the embedding component 1120 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 1130 and/or other components of the generative LM system 1100 may use different types of neural network architectures depending on the embodiment. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the embodiment and architecture, the embedding component 1120 may apply an encoded representation of the input 1101 to the generative LM 1130, and the generative LM 1130 may process the encoded representation of the input 1101 to generate an output 1190, which may include responsive text and/or other types of data.

As described herein, in some embodiments, the generative LM 1130 may be configured to access or use—or capable of accessing or using—plug-ins/APIs 1195 (which may include one or more plug-ins, application programming interfaces (APIs), databases, data stores, repositories, etc.). For example, for certain tasks or operations that the generative LM 1130 is not ideally suited for, the model may have instructions (e.g., as a result of training, and/or based on instructions in a given prompt, such as those retrieved using the RAG component 1192) to access one or more plug-ins/APIs 1195 (e.g., 3rd party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 1195 to the plug-in/API 1195, the plug-in/API 1195 may process the information and return an answer to the generative LM 1130, and the generative LM 1130 may use the response to generate the output 1190. This process may be repeated—e.g., recursively—for any number of iterations and using any number of plug-ins/APIs 1195 until an output 1190 that addresses each ask/question/request/process/operation/etc. from the input 1101 can be generated. As such, the model(s) may not only rely on its own knowledge from training on a large dataset(s) and/or from data retrieved using the RAG component 1192, but also on the expertise or optimized nature of one or more external resources—such as the plug-ins/APIs 1195.

FIG. 11B is a block diagram of an example embodiment in which the generative LM 1130 includes a transformer encoder-decoder. For example, assume input text such as “Who discovered gravity” is tokenized (e.g., by the tokenizer 1110 of FIG. 11A) into tokens such as words, and each token is encoded (e.g., by the embedding component 1120 of FIG. 911A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 1135 of the generative LM 1130.

In an example embodiment, the encoder(s) 1135 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 1140 may convert the context vector into attention vectors (keys and values) for the decoder(s) 1145.

In an example embodiment, the decoder(s) 1145 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 1135, in an example transformer architecture, each token (e.g., word) flows through a separate path in the decoder(s) 1145. During a first pass, the decoder(s) 1145, a classifier 1150, and a generation mechanism 1155 may generate a first token, and the generation mechanism 1155 may apply the generated token as an input during a second pass. The process may repeat in a loop, successively generating and adding tokens (e.g., words) to the output from the preceding pass and applying the token embeddings of the composite sequence with positional encodings as an input to the decoder(s) 1145 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example embodiment, the encoder-decoder attention layer operates similarly to the (e.g., multi-headed) self-attention in the encoder(s) 1135, except that it creates its queries from the layer below it and takes the keys and values (e.g., matrix) from the output of the encoder(s) 1135.

As such, the decoder(s) 1145 may output some decoded (e.g., vector) representation of the input being applied during a particular pass. The classifier 1150 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 1155 may select or sample a word or token based on a corresponding predicted probability (e.g., select the word with the highest predicted probability) and append it to the output from a previous pass, generating each word or token sequentially. The generation mechanism 1155 may repeat the process, triggering successive decoder inputs and corresponding predictions until selecting or sampling a symbol or token that represents the end of the response, at which point, the generation mechanism 1155 may output the generated response.

FIG. 11C is a block diagram of an example embodiment in which the generative LM 1130 includes a decoder-only transformer architecture. For example, the decoder(s) 1160 of FIG. 11C may operate similarly as the decoder(s) 1145 of FIG. 11B except each of the decoder(s) 1160 of FIG. 11C omits the encoder-decoder self-attention layer (since there is no encoder in this embodiment). As such, the decoder(s) 1160 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 1160. As with the decoder(s) 1145 of FIG. 11B, each token (e.g., word) may flow through a separate path in the decoder(s) 1160, and the decoder(s) 1160, a classifier 1165, and a generation mechanism 1170 may use auto-regression to sequentially generate one token at a time until predicting a symbol or token that represents the end of the response. The classifier 1165 and the generation mechanism 1170 may operate similarly as the classifier 1150 and the generation mechanism 1155 of FIG. 11B, with the generation mechanism 1170 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Computing Device

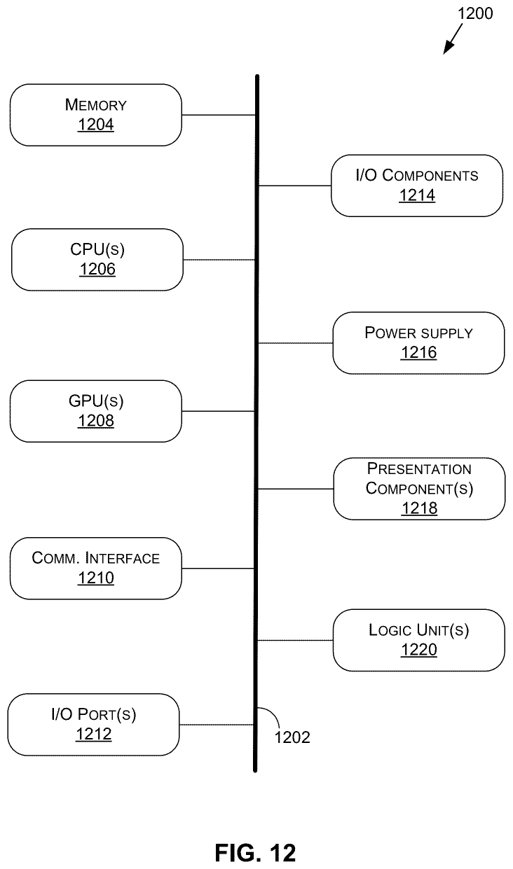

FIG. 12 is a block diagram of an example computing device(s) 1200 suitable for use in implementing some embodiments of the present disclosure. Computing device 1200 may include an interconnect system 1202 that directly or indirectly couples the following devices: memory 1204, one or more central processing units (CPUs) 1206, one or more graphics processing units (GPUs) 1208, a communication interface 1210, input/output (I/O) ports 1212, input/output components 1214, a power supply 1216, one or more presentation components 1218 (e.g., display(s)), and one or more logic units 1220. In at least one embodiment, the computing device(s) 1200 may comprise one or more virtual machines (VMs), and/or any of the components thereof may comprise virtual components (e.g., virtual hardware components). For non-limiting examples, one or more of the GPUs 1208 may comprise one or more vGPUs, one or more of the CPUs 1206 may comprise one or more vCPUs, and/or one or more of the logic units 1220 may comprise one or more virtual logic units. As such, a computing device(s) 1200 may include discrete components (e.g., a full GPU dedicated to the computing device 1200), virtual components (e.g., a portion of a GPU dedicated to the computing device 1200), or a combination thereof.

Although the various blocks of FIG. 12 are shown as connected via the interconnect system 1202 with lines, this is not intended to be limiting and is for clarity only. For example, in some embodiments, a presentation component 1218, such as a display device, may be considered an I/O component 1214 (e.g., if the display is a touch screen). As another example, the CPUs 1206 and/or GPUs 1208 may include memory (e.g., the memory 1204 may be representative of a storage device in addition to the memory of the GPUs 1208, the CPUs 1206, and/or other components). As such, the computing device of FIG. 12 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 12.

The interconnect system 1202 may represent one or more links or busses, such as an address bus, a data bus, a control bus, or a combination thereof. The interconnect system 1202 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1206 may be directly connected to the memory 1204. Further, the CPU 1206 may be directly connected to the GPU 1208. Where there is direct, or point-to-point connection between components, the interconnect system 1202 may include a PCIe link to carry out the connection. In these examples, a PCI bus need not be included in the computing device 1200.

The memory 1204 may include any of a variety of computer-readable media. The computer-readable media may be any available media that may be accessed by the computing device 1200. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1204 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1200. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1206 may be configured to execute at least some of the computer-readable instructions to control one or more components of the computing device 1200 to perform one or more of the methods and/or processes described herein. The CPU(s) 1206 may each include one or more cores (e.g., one, two, four, eight, twenty-eight, seventy-two, etc.) that are capable of handling a multitude of software threads simultaneously. The CPU(s) 1206 may include any type of processor, and may include different types of processors depending on the type of computing device 1200 implemented (e.g., processors with fewer cores for mobile devices and processors with more cores for servers). For example, depending on the type of computing device 1200, the processor may be an Advanced RISC Machines (ARM) processor implemented using Reduced Instruction Set Computing (RISC) or an x86 processor implemented using Complex Instruction Set Computing (CISC). The computing device 1200 may include one or more CPUs 1206 in addition to one or more microprocessors or supplementary co-processors, such as math co-processors.

In addition to or alternatively from the CPU(s) 1206, the GPU(s) 1208 may be configured to execute at least some of the computer-readable instructions to control one or more components of the computing device 1200 to perform one or more of the methods and/or processes described herein. One or more of the GPU(s) 1208 may be an integrated GPU (e.g., with one or more of the CPU(s) 1206 and/or one or more of the GPU(s) 1208 may be a discrete GPU. In embodiments, one or more of the GPU(s) 1208 may be a coprocessor of one or more of the CPU(s) 1206. The GPU(s) 1208 may be used by the computing device 1200 to render graphics (e.g., 3D graphics) or perform general purpose computations. For example, the GPU(s) 1208 may be used for General-Purpose computing on GPUs (GPGPU). The GPU(s) 1208 may include hundreds or thousands of cores that are capable of handling hundreds or thousands of software threads simultaneously. The GPU(s) 1208 may generate pixel data for output images in response to rendering commands (e.g., rendering commands from the CPU(s) 1206 received via a host interface). The GPU(s) 1208 may include graphics memory, such as display memory, for storing pixel data or any other suitable data, such as GPGPU data. The display memory may be included as part of the memory 1204. The GPU(s) 1208 may include two or more GPUs operating in parallel (e.g., via a link). The link may directly connect the GPUs (e.g., using NVLINK) or may connect the GPUs through a switch (e.g., using NVSwitch). When combined together, each GPU 1208 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1206 and/or the GPU(s) 1208, the logic unit(s) 1220 may be configured to execute at least some of the computer-readable instructions to control one or more components of the computing device 1200 to perform one or more of the methods and/or processes described herein. In embodiments, the CPU(s) 1206, the GPU(s) 1208, and/or the logic unit(s) 1220 may discretely or jointly perform any combination of the methods, processes and/or portions thereof. One or more of the logic units 1220 may be part of and/or integrated in one or more of the CPU(s) 1206 and/or the GPU(s) 1208 and/or one or more of the logic units 1220 may be discrete components or otherwise external to the CPU(s) 1206 and/or the GPU(s) 1208. In embodiments, one or more of the logic units 1220 may be a coprocessor of one or more of the CPU(s) 1206 and/or one or more of the GPU(s) 1208.

Examples of the logic unit(s) 1220 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Trec Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1210 may include one or more receivers, transmitters, and/or transceivers that allow the computing device 1200 to communicate with other computing devices via an electronic communication network, included wired and/or wireless communications. The communication interface 1210 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1220 and/or communication interface 1210 may include one or more data processing units (DPUs) to transmit data received over a network and/or through interconnect system 1202 directly to (e.g., a memory of) one or more GPU(s) 1208.

The I/O ports 1212 may allow the computing device 1200 to be logically coupled to other devices including the I/O components 1214, the presentation component(s) 1218, and/or other components, some of which may be built in to (e.g., integrated in) the computing device 1200. Illustrative I/O components 1214 include a microphone, mouse, keyboard, joystick, game pad, game controller, satellite dish, scanner, printer, wireless device, etc. The I/O components 1214 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1200. The computing device 1200 may be include depth cameras, such as stereoscopic camera systems, infrared camera systems, RGB camera systems, touchscreen technology, and combinations of these, for gesture detection and recognition. Additionally, the computing device 1200 may include accelerometers or gyroscopes (e.g., as part of an inertia measurement unit (IMU)) that allow detection of motion. In some examples, the output of the accelerometers or gyroscopes may be used by the computing device 1200 to render immersive augmented reality or virtual reality.

The power supply 1216 may include a hard-wired power supply, a battery power supply, or a combination thereof. The power supply 1216 may provide power to the computing device 1200 to allow the components of the computing device 1200 to operate.

The presentation component(s) 1218 may include a display (e.g., a monitor, a touch screen, a television screen, a heads-up-display (HUD), other display types, or a combination thereof), speakers, and/or other presentation components. The presentation component(s) 1218 may receive data from other components (e.g., the GPU(s) 1208, the CPU(s) 1206, DPUs, etc.), and output the data (e.g., as an image, video, sound, etc.).

### Example Data Center

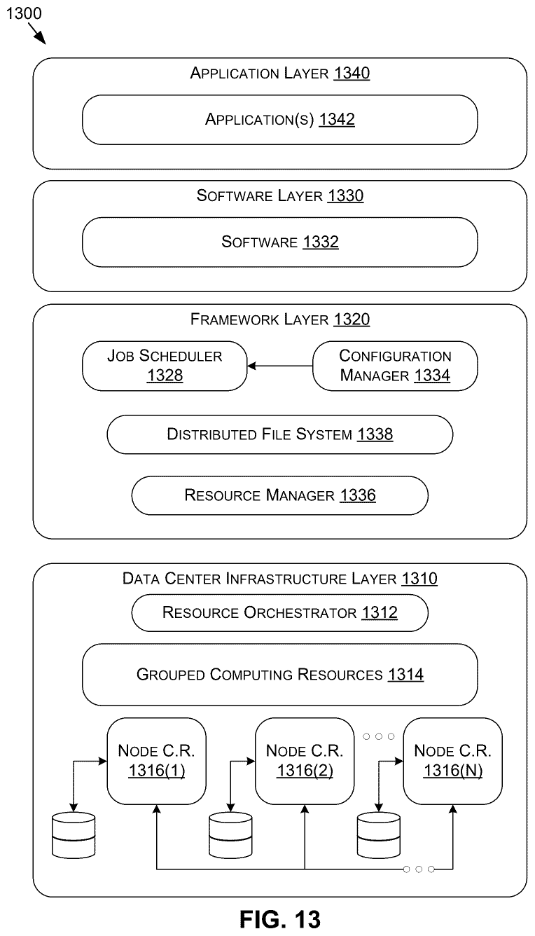

FIG. 13 illustrates an example data center 1300 that may be used in at least one embodiments of the present disclosure. The data center 1300 may include a data center infrastructure layer 1310, a framework layer 1320, a software layer 1330, and/or an application layer 1340.

As shown in FIG. 13, the data center infrastructure layer 1310 may include a resource orchestrator 1312, grouped computing resources 1314, and node computing resources (“node C.R.s”) 1316(1)-1316(N), where “N” represents any whole, positive integer. In at least one embodiment, node C.R.s 1316(1)-1316(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1316(1)-1316(N) may correspond to a server having one or more of the above-mentioned computing resources. In addition, in some embodiments, the node C.R.s 1316(1)-13161(N) may include one or more virtual components, such as vGPUs, vCPUs, and/or the like, and/or one or more of the node C.R.s 1316(1)-1316(N) may correspond to a virtual machine (VM).

In at least one embodiment, grouped computing resources 1314 may include separate groupings of node C.R.s 1316 housed within one or more racks (not shown), or many racks housed in data centers at various geographical locations (also not shown). Separate groupings of node C.R.s 1316 within grouped computing resources 1314 may include grouped compute, network, memory or storage resources that may be configured or allocated to support one or more workloads. In at least one embodiment, several node C.R.s 1316 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1312 may configure or otherwise control one or more node C.R.s 1316(1)-1316(N) and/or grouped computing resources 1314. In at least one embodiment, resource orchestrator 1312 may include a software design infrastructure (SDI) management entity for the data center 1300. The resource orchestrator 1312 may include hardware, software, or some combination thereof.

In at least one embodiment, as shown in FIG. 13, framework layer 1320 may include a job scheduler 1328, a configuration manager 1334, a resource manager 1336, and/or a distributed file system 1338. The framework layer 1320 may include a framework to support software 1332 of software layer 1330 and/or one or more application(s) 1342 of application layer 1340. The software 1332 or application(s) 1342 may respectively include web-based service software or applications, such as those provided by Amazon Web Services, Google Cloud and Microsoft Azure. The framework layer 1320 may be, but is not limited to, a type of free and open-source software web application framework such as Apache Spark™ (hereinafter “Spark”) that may use distributed file system 1338 for large-scale data processing (e.g., “big data”). In at least one embodiment, job scheduler 1328 may include a Spark driver to facilitate scheduling of workloads supported by various layers of data center 1300. The configuration manager 1334 may be capable of configuring different layers such as software layer 1330 and framework layer 1320 including Spark and distributed file system 1338 for supporting large-scale data processing. The resource manager 1336 may be capable of managing clustered or grouped computing resources mapped to or allocated for support of distributed file system 1338 and job scheduler 1328. In at least one embodiment, clustered or grouped computing resources may include grouped computing resource 1314 at data center infrastructure layer 1310. The resource manager 1336 may coordinate with resource orchestrator 1312 to manage these mapped or allocated computing resources.

In at least one embodiment, software 1332 included in software layer 1330 may include software used by at least portions of node C.R.s 1316(1)-1316(N), grouped computing resources 1314, and/or distributed file system 1338 of framework layer 1320. One or more types of software may include, but are not limited to, Internet web page search software, e-mail virus scan software, database software, and streaming video content software.

In at least one embodiment, application(s) 1342 included in application layer 1340 may include one or more types of applications used by at least portions of node C.R.s 1316(1)-1316(N), grouped computing resources 1314, and/or distributed file system 1338 of framework layer 1320. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1334, resource manager 1336, and resource orchestrator 1312 may implement any number and type of self-modifying actions based on any amount and type of data acquired in any technically feasible fashion. Self-modifying actions may relieve a data center operator of data center 1300 from making possibly bad configuration decisions and possibly avoiding underutilized and/or poor performing portions of a data center.

The data center 1300 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1300. In at least one embodiment, trained or deployed machine learning models corresponding to one or more neural networks may be used to infer or predict information using resources described above with respect to the data center 1300 by using weight parameters calculated through one or more training techniques, such as but not limited to those described herein.

In at least one embodiment, the data center 1300 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1200 of FIG. 12—e.g., each device may include similar components, features, and/or functionality of the computing device(s) 1200. In addition, where backend devices (e.g., servers, NAS, etc.) are implemented, the backend devices may be included as part of a data center 1300, an example of which is described in more detail herein with respect to FIG. 13.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1200 described herein with respect to FIG. 12. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

Other variations are within the spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. Term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. Use of term “set” (e.g., “a set of items”) or “subset,” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, term “plurality” indicates a state of being plural (e.g., “a plurality of items” indicates multiple items). A plurality is at least two items, but may be more when so indicated either explicitly or by context. Further, unless stated otherwise or otherwise clear from context, phrase “based on” means “based at least in part on” and not “based solely on.”

Operations of processes described herein may be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. A set of non-transitory computer-readable storage media, in at least one embodiment, comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. Terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. Obtaining, acquiring, receiving, or inputting analog and digital data may be accomplished in a variety of ways such as by receiving data as a parameter of a function call or a call to an application programming interface. In some embodiments, process of obtaining, acquiring, receiving, or inputting analog or digital data may be accomplished by transferring data via a serial or parallel interface. In another embodiment, process of obtaining, acquiring, receiving, or inputting analog or digital data may be accomplished by transferring data via a computer network from providing entity to acquiring entity. References may also be made to providing, outputting, transmitting, sending, or presenting analog or digital data. In various examples, process of providing, outputting, transmitting, sending, or presenting analog or digital data may be accomplished by transferring data as an input or output parameter of a function call, a parameter of an application programming interface or interprocess communication mechanism.

Although discussion above sets forth example embodiments of described techniques, other architectures may be used to implement described functionality, and are intended to be within scope of this disclosure. Furthermore, although specific distributions of responsibilities are defined above for purposes of discussion, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
receiving, from a client device, a selection of a first task for a large language model (LLM);
instantiating an execution container comprising one or more compute backends;
receiving, using an evaluation application programming interface (API), task data into the execution container, the task data comprising one or more LLM prompts;
executing, using the one or more compute backends, the first task in the execution container to generate a task output, the task output comprising at least one of:
one or more responses, generated by the LLM, to the one or more LLM prompts of the task data, or
a modification of one or more parameters of the LLM based at least on the one or more LLM prompts of the task data;
evaluating, using one or more evaluation benchmarks accessed by the evaluation API, the task output to obtain one or more values of one or more metrics characterizing performance of the LLM; and
executing, responsive to at least the one or more values of the one or more metrics, a second task using the LLM.

2. The method of claim 1, wherein the first task for the LLM comprises:
training the LLM using the task data,
fine-tuning the LLM using the task data, or
performing, using the LLM, inference processing of the task data.

3. The method of claim 1, wherein the one or more compute backends comprise at least one of:
a TensorFlow backend,
a PyTorch backend,
a TensorRT backend,
a ONNX backend, or
a Keras backend.

4. The method of claim 1, wherein the task data comprises retrieval augmentation database (RAG) data retrieved using a RAG system, and wherein the one or more values of the one or more metrics characterize performance of the LLM operating in conjunction with the RAG system.

5. The method of claim 1, further comprising:
displaying, using the evaluation API, a plurality of evaluation benchmarks on a user interface (UI);
wherein the one or more evaluation benchmarks are selected based on at least one of:
a user selection of the one or more evaluation benchmarks from the plurality of evaluation benchmarks, or
a default selection of the one or more evaluation benchmarks from the plurality of evaluation benchmarks.

6. The method of claim 5, wherein the plurality of evaluation benchmarks comprises at least one of:
one or more public evaluation benchmarks, or
one or more proprietary evaluation benchmarks accessible to the client device.

7. The method of claim 5, wherein the default selection is based at least on a type of the first task.

8. The method of claim 1, wherein the executing the second task comprises:
determining, using the one or more values of the one or more metrics, that the executing the first task has resulted in a decrease of one or more skills previously learned by the LLM; and
causing one or more operations for refreshing the one or more skills previously learned by the LLM.

9. The method of claim 1, further comprising:
generating an LLM performance report comprising the one or more values of the one or more metrics and at least one of:
one or more historical values of the one or more metrics characterizing past performance of the LLM; or
one or more additional values of one or more additional metrics characterizing performance of at least one additional LLM different from the LLM; and
sending, using the evaluation API and to the client device, data corresponding to the LLM performance report to cause the LLM performance report to be presented in a user interface (UI) of the client device.

10. The method of claim 1, further comprising:
determining a correspondence of the one or more values of the one or more metrics to a threshold condition; and
displaying on a user interface, responsive to the correspondence, at least one of:
an alert that the LLM has achieved a target performance, or
an alert that an improvement of the LLM caused by the executing of the first task is below a target improvement.

11. The method of claim 1, wherein the task data comprises a first data and a second data, wherein the executing the first task to generate the task output comprises:
processing, using the LLM, the first data to obtain a first output of the task output, and
processing, using the LLM, the second data to obtain a second output of the task output; and
wherein the evaluating the task output comprises:
obtaining a comparison of the first output to the second output; and
generating, based on at least the obtained comparison, a task data performance report for the first data and the second data.

12. A system comprising:
one or more processors to:
receive, from a client device, a selection of a task for a large language model (LLM);
instantiate an execution container comprising one or more compute backends;
receive, via an evaluation application programming interface (API), task data into the execution container, the task data comprising one or more LLM prompts;
execute, using the one or more compute backends, the task in the execution container to generate a task output, the task output comprising at least one of:
one or more responses, generated by the LLM, to the one or more LLM prompts of the task data, or
a modification of one or more parameters of the LLM based at least on the one or more LLM prompts of the task data;
evaluate, using one or more evaluation benchmarks accessed by the evaluation API, the task output to obtain one or more values of one or more metrics characterizing performance of the LLM; and
send data corresponding to the one or more values of the one or more metrics to the client device to cause presentation, within a user interface (UI) of the client device, the one or more values of the one or more metrics.

13. The system of claim 12, wherein the task for the LLM comprises:
training the LLM using the task data,
fine-tuning the LLM using the task data, or
performing, using the LLM, inference processing of the task data.

14. The system of claim 12, wherein the one or more evaluation benchmarks are selected based on at least one of:
a user selection of the one or more evaluation benchmarks from the plurality of evaluation benchmarks comprising at least one of (i) one or more public evaluation benchmarks or (ii) one or more proprietary evaluation benchmarks accessible to the client device,
a default selection of the one or more evaluation benchmarks from the plurality of evaluation benchmarks, the default selection based on at least a type of the task.

15. The system of claim 12, wherein the one or more processors are further to:
determine, using the one or more values of the one or more metrics, that the executing the task has resulted in a decrease of one or more skills previously learned by the LLM; and
cause performance of one or more operations to refresh the one or more skills previously learned by the LLM.

16. The system of claim 12, wherein the one or more processors are further to:
generate an LLM performance report comprising the one or more values of the one or more metrics and at least one of:
one or more historical values of the one or more metrics characterizing past performance of the LLM; or
one or more additional values of one or more additional metrics characterizing performance of at least one additional LLM different from the LLM.

17. The system of claim 12, wherein the one or more processors are further to:
determine a correspondence of the one or more values of the one or more metrics to a threshold condition; and
wherein the UI includes, responsive to the correspondence, at least one of:
an alert that the LLM has achieved a target performance, or
an alert that an improvement of the LLM caused by the executing of the task is below a target improvement.

18. The system of claim 12, wherein the task data comprises a first data and a second data, wherein to execute the task to generate the task output, the one or more processors are to:
process, using the LLM, the first data to obtain a first output of the task output, and
process, using the LLM, the second data to obtain a second output of the task output; and
wherein to evaluate the task output, the one or more processors are to:
obtain a comparison of the first output to the second output; and
generate, based on at least the obtained comparison, a task data performance report for the first data and the second data.

19. The system of claim 12, wherein the system is comprised in at least one of:
an in-vehicle infotainment system for an autonomous or semi-autonomous machine;
a system for performing one or more simulation operations;
a system for performing one or more digital twin operations;
a system for performing light transport simulation;
a system for performing medical operations;
a system for performing factory operations;
a system for performing collaborative content creation for 3D assets;
a system for performing one or more deep learning operations;
a system implemented using an edge device;
a system for generating or presenting at least one of virtual reality content, mixed reality content, or augmented reality content;
a system implemented using a robot;
a system for performing one or more conversational AI operations;
a system implementing one or more large language models (LLMs);
a system implementing one or more language models;
a system implementing one or more vision language models (VLMs);
a system implementing one or more multi-modal language models;
a system for performing one or more generative AI operations;
a system for generating synthetic data;
a system incorporating one or more virtual machines (VMs);
a system implemented at least partially in a data center; or
a system implemented at least partially using cloud computing resources.

20. At least one processor comprising processing circuitry to:
receive, from a client device, a selection of a task for a language model (LM);
instantiate an execution container comprising one or more compute backends;
receive, using an evaluation application programming interface (API), task data into the execution container, the task data comprising one or more LM prompts;
execute, using the one or more compute backends, the task in the execution container to generate a task output;
evaluate, using one or more evaluation benchmarks accessed using the evaluation API, the task output to obtain one or more values of one or more metrics characterizing performance of the LLM; and
send, to the client device, data corresponding to the one or more values of the one or more metrics to cause the client device to populate the one or more values within a user interface (UI) executing on the client device.
